(19) United States
(12) Patent Application Publication
(10) Pub. No.: US 2011/0129575 A1
(43) Pub. Date: Jun. 2, 2011

(54) BATTER COMPOSITIONS AND METHODS OF PREPARING AND USING SAME

(76) Inventors: Weijie Li, Gem Lake, MN (US); Gregg J. Moder, Roseville, MN (US); Tonya C. Schoenfuss, Buffalo, MN (US); Liza B. Levin, Plymouth, MN (US); Debra L. Patterson, Minnetonka, MN (US); Stephen Green, Plymouth, MN (US)

(21) Appl. No.: 12/299,911

(22) PCT Filed: May 10, 2006
(86) PCT No.: PCT/US06/18423

§ 371 Date: Feb. 26, 2010

(51) Int. Cl. A21D 10/04; A21D 2/00; B65D 81/34; A21D 13/06

(52) U.S. Cl. 426/94; 426/552; 426/622; 426/113

(57) ABSTRACT

The invention provides batter compositions including a structure-providing amount of a flour replacement ingredient comprising native starch in an amount of 70% by weight or more, and a protein source in an amount of 30% by weight or less, weight percentages based upon weight of the flour replacement ingredient; a sweetener in an amount effective to provide a water activity of 0.94 or less; and a fat source, wherein the batter composition has a pH of 6.5 or higher. Optionally, the flour replacement ingredient can further include a fiber source, a minor amount of modified starch, or a combination of these. In some aspects, the invention provides batter compositions including a novel leavening system.

### FIELD OF THE INVENTION

The invention relates to batter compositions containing a flour replacement ingredient. The invention further relates to methods of making such batter compositions, as well as baked or cooked goods made from such batter compositions.

### BACKGROUND OF THE INVENTION

Certain moist baked goods such as muffins, pancakes, cakes, brownies, and the like are typically made from scratch or from a dry mix, where consumers make a batter by adding liquids to dry ingredients and then bake the batter soon after mixing. While these methods can produce high quality baked goods, preparation of the batters can be time consuming. Moreover, the batter should be used by the consumer immediately to provide for optimum leavening action and to minimize microbiological growth.

Some of these issues have been overcome by preparing muffins and other batter-based baked goods from frozen batters, wherein the consumer thaws and then bakes the batter. These batters have a slightly lower water activity (A_{w}) than batters prepared from scratch or dry mixes. Additionally, these batters can be stored for about 48 hours under refrigerated conditions after thawing, while maintaining leavening and microbial stability properties. However, the refrigerated storage life of the batter once thawed is typically short (often on the order of a few days). If the entire batch is not used relatively quickly, there is the risk that the unused portion of the batter will spoil and lose leavening capacity.

Refrigerated batters generally have relatively short shelf-lives, typically less than 45 days. Such inadequate shelf life can be the result of poor microbiological status after storing the liquid mixture refrigerated for a couple of days. Generally speaking, microbial stability issues have been addressed by inclusion of preservatives, management of water content (including water activity) of the batters, and/or management of the pH of the batter systems. Another challenge for refrigerated batters is the color of the batter during storage. Some enzymes naturally present in flour can cause discoloration of batter in a relatively short period of time, i.e., in a matter of hours to days. In particular, polyphenol oxidases (PPOs) are naturally present in flour, and their action causes darkening and discoloration of batter during storage. Although such enzymatic action primarily impacts the appearance of the batter, darkening can cause a consumer to believe the batter composition is no longer edible. The presence of enzymes can contribute to another challenge for refrigerated batters, namely, maintenance of batter viscosity over the period of storage. The presence of enzymes such as amylases can contribute to break down of components of the batter (such as starch), thereby leading to thinning of the batter over time. Yet another challenge for refrigerated batters can be control of leavening activity. Generally speaking, it is desirable to avoid substantial leavening until the batter is put into a baking environment (i.e., elevated temperatures) to prepare the final baked good. Premature leavening has been addressed by encapsulating some or all of the leavening components, such that the leavening acid and leavening base cannot react until baking temperatures are encountered.

One approach to improving shelf stability of flour and dough compositions has been heat-treatment of flour prior to formulating the dough. See, for example, U.S. Pat. No. 6,616,957 (Wilhelm et al.), U.S. Publication Nos. 2004/0043123 A1 (Triantafyllou Oste et al.) and 2005/0255219 A1 (Dreese et al.), and PCT Publication No. WO 2005/110117 A1 (Dreese). This approach has limitations, as it adds cost to manufacturing processes, some enzymes can survive the heat-treatment process, and/or heat-treatment can have the effect of partially activating enzymes remaining in the flour.

### SUMMARY OF THE INVENTION

Generally, the invention provides batter compositions comprising a structure-providing amount of a flour replacement ingredient comprising native starch in an amount of 70% by weight or more, and a protein source in an amount of 30% by weight or less, weight percentages based upon weight of the flour replacement ingredient; a sweetener in an amount effective to provide a water activity of 0.94 or less; and a fat source, wherein the batter composition has a pH of 6.5 or higher. The inventive batter compositions thus include a novel flour replacement ingredient, which in some aspects provides improved properties to the compositions. In other aspects of the invention, the inventive batter compositions can include minor amounts of flour, as described herein, typically in amounts that will not adversely impact desirable properties of the batter compositions. For example, minor amounts can be amounts less than a structure-providing amount, for example, 5% or less of the batter composition.

In accordance with the invention, the flour replacement ingredient can include a majority of native starch. When desired, an amount of modified starch can be included in the flour replacement ingredient to modify the overall viscosity of the batter compositions. In some aspects, modified starch can be included in an amount up to 25% by weight of the flour replacement ingredient (up to 5% by weight of the total batter composition). The flour replacement ingredient furthers includes a protein source and, optionally, a fiber source. The optional components of the flour replacement ingredient can provide desirable features to the batter compositions, as will be described.

According to the invention, the flour replacement ingredient provides properties to a batter formed therefrom that were conventionally supplied by the flour ingredient in farinaceous products. The flour replacement ingredient can thus provide structure to a batter composition. At the same time, however, it has been found that the flour replacement ingredient can, in some embodiments, avoid undesirable properties that can be present when flour is present in a formulation, such as undesirable enzymatic reactions. The resulting batter compositions of the invention thus provide enhanced shelf stability while retaining the desirable properties (such as, for example, leavening activity, desirable color, and the like) typically desired in batter compositions.

In further aspects, the invention provides a flour replacement ingredient for use in providing structure to a batter. According to these aspects, the invention provides a flour replacement ingredient for use in providing structure in a batter, the flour replacement ingredient comprising at least 70% by weight of native starch, protein source in an amount of 30% by weight or less, fiber source in an amount of 20% by weight or less, weight percentages based on total weight of the flour replacement ingredient.

In some aspects, the batter compositions can be stored at refrigerated temperatures, for example, in the range of about 30° F. (−1° C.) to about ambient temperature, or in the range of about 35° F. (1° C.) to about 45° F. (7° C.), or in the range of about 38° F. (3° C.) to about 42° F. (5° C.). Alternatively, the batter compositions can be stored at ambient temperatures, for example, temperatures in the range of about 50° F. to about 85° F. (about 18° C. to about 30° C.).

The batter compositions can provide desirable baked or cooked products that are similar to those prepared either from scratch from conventional batters or from dry mixes. Preferred batter compositions of the invention can have an uncooked density in the range of about 0.8 g/cc (grams per cubic centimeter) to about 1.2 g/cc at ambient or refrigerated temperatures. As discussed herein, the inventive compositions can be utilized to prepare a wide variety of baked or cooked products; thus, one of skill in the art will readily appreciate that the uncooked density of the batter compositions can vary widely, depending upon the baked or cooked product to be prepared.

The inventive batter compositions are typically useful for preparing products conventionally produced from chemically-leavened flour-based (farinaceous) batters. Baked or cooked products that can be prepared from the inventive batter compositions can include, for example, muffins, pancakes, brownies, cakes, coffee cakes, quick breads, corn breads, funnel cakes, and the like. In other aspects, the inventive batter compositions are useful for preparing unleavened products, such as unleavened breads and cakes.

In further method aspects, the invention provides methods of formulating a batter composition comprising: providing a flour replacement ingredient comprising starch and protein source, combining the flour replacement ingredient with sweetener and fat source to provide a batter composition, wherein the starch of the flour replacement ingredient includes at least native starch, and can further include modified starch in an amount in the range of 0 to 5% based on total weight of the batter composition, and wherein the amount of modified starch in the batter composition is selected to provide a desired viscosity to the batter composition, and wherein the flour replacement ingredient is present in an amount sufficient to provide structure to the batter.

In accordance with some aspects, the invention provides a batter composition comprising a structure-providing amount of flour or flour replacement ingredient; sweetener in an amount effective to provide a water activity of 0.94 or less; fat source; and a chemical leavening system, the chemical leavening system comprising a basic leavening agent and an acidic leavening agent, wherein dimagnesium phosphate trihydrate comprises at least 75% by weight of the acidic leavening agent. In other aspects, the dimagnesium phosphate trihydrate can comprise 80% or more, or 85% or more, or 90% or more, or 95% or more, or 100% of the acidic leavening acid. In some aspects, the inventive batter compositions include less than 30% by weight, or less than 20% or less than 10% or less than 5% amorphous magnesium phosphate based on weight of the acidic leavening agent.

In further aspects, the invention provides a food package kit comprising a container suitable for microwave cooking; and at least one batter composition disposed in the container, the batter composition comprising a flour replacement ingredient comprising at least 70% by weight native starch and 30% by weight or less of a protein source; a sweetener in an amount effective to provide a water activity of 0.94 or less; and a fat source, wherein the flour replacement ingredient is present in a structure-providing amount.

In additional aspects, the invention provides a food package kit comprising a container suitable for baking in an oven; and at least a batter composition located proximate to the container, the batter composition comprising a flour replacement ingredient comprising at least 70% by weight native starch and 30% by weight or less of a protein source; a sweetener in an amount effective to provide a water activity of 0.94 or less; and a fat source, wherein the flour replacement ingredient is present in a structure-providing amount. The food package kit also includes a retaining element for maintaining the batter composition proximate to the container. Optionally, an outer sleeve can be provided in conjunction with the container, wherein the sleeve is designed to hold the container firmly in place within the sleeve. In some aspects, the outer sleeve can serve as a retaining element.

Illustrative packaging can include, for example, a container such as a pouch, bowl, cup or tray that is optionally bakable and/or microwavable. Such container can include a flexible film or wrap, and/or a nested lid, if desired. Additionally, the batter composition can be included in a modified atmosphere within the packaging, if desired. The total moisture content will of course be product specific, for example, in the range of about 30% to about 50% for muffins, and about 50% for pancake batters.

For purposes of illustration, use of the inventive compositions and methods to prepare cakes will be described in detail. Cakes have been selected because these cooked goods are typically prepared from dry mixes or from scratch; thus, the advantages of stability and preparation efficiency resulting from the invention can be easily illustrated. Moreover, consumers have certain expectations of cake products, such as soft, moist product texture and acceptable cooked specific volume. Thus, these systems provide the ability to describe the desirable organoleptic properties of baked or cooked goods prepared from the inventive batter compositions and systems.

These and other aspects and advantages will now be described in more detail.

### BRIEF DESCRIPTION OF THE DRAWINGS

The accompanying drawings, which are incorporated in and constitute a part of this specification, illustrate several aspects of the invention and together with the description of the various embodiments, serve to explain the principles of the invention. A brief description of the drawings is as follows:

FIG. 1 is a graph illustrating cake height for batter compositions according to the invention, wherein batter formula is represented on the X-axis and height (mm) is represented on the Y-axis.

FIG. 2 is a graph illustrating color variation (white/black) for batter compositions, wherein time (days) is represented on the X-axis and “L” value is represented on the Y-axis.

FIG. 3 is a graph illustrating color variation (red/green) for batter compositions, wherein time (days) is represented on the X-axis and “a” value is represented on the Y-axis.

FIG. 4 is a graph illustrating color variation (yellow/blue) for batter compositions, wherein time (days) is represented on the X-axis and “b” value is represented on the Y-axis.

FIG. 5 is a graph illustrating pouch volume for various leavening systems, wherein product sample and temperature (° C.) are represented on the X-axis and pouch volume (cubic centimeters, cc) is represented on the Y-axis.

FIG. 6 is a graph illustrating baked product height for various leavening systems, wherein product sample and temperature (° C.) are represented on the X-axis and baked product height is represented on the Y-axis (in mm).

FIG. 7 is a table including formulations of batter compositions containing various chemical leavening systems.

FIG. 8 is a graph illustrating baked product height (for cakes) for batter compositions, wherein the leavening acid within each batter composition is represented on the X-axis and height (in mm) is represented on the Y-axis.

FIG. 9 is a graph illustrating shear viscosity of a flowable batter composition, wherein shear rate (1/sec) is represented on the X-axis and viscosity (centipoise, cP) is represented on the Y-axis.

FIG. 10 is a graph illustrating shear viscosity of a non-flowable batter composition, wherein shear rate (1/sec) is represented on the X-axis and viscosity (centipoise, cP) is represented on the Y-axis.

### DETAILED DESCRIPTION OF THE INVENTION

The embodiments of the invention described below are not intended to be exhaustive or to limit the invention to the precise forms disclosed in the following detailed description. Rather, the embodiments are chosen and described so that others skilled in the art can appreciate and understand the principles and practices of the invention.

Throughout the specification and claims, percentages are by weight and temperatures in degrees Fahrenheit unless otherwise indicated. Unless otherwise indicated, all formulations include functional ingredients and do not include the addition of inclusions.

As used herein, the term “dough” refers to an intermediate food product that has a gluten based structure. In dough, the gluten forms a continuous dough elastic medium into which other ingredients can be embedded. A dough is typically prepared by beating, blending, cutting, and/or kneading, and is often stiff enough to cut into various shapes. Doughs typically are used for low sugar-to-flour ratio products such as breads, biscuits, and the like.

In contrast, “batter” in a conventional sense refers to an intermediate food product that essentially contains flour, water, and salt, and optionally fat, eggs, and sweetener(s). In a batter, gluten development is purposefully minimized. In general, batters are understood to be less viscous than doughs. Batters are typically inelastic. Liquid added to make the batter forms a continuous batter medium in which other ingredients can be dispersed. A batter cooks into a soft, moist and sometimes crumbly product. A batter is typically prepared by blending, creaming, stirring, and/or whipping, and is generally flowable enough to pour or scoop or squeeze out of a container.

In some aspects, the batter compositions herein can be described as “ready-to-cook” batters. In these aspects, the batter compositions are formulated as complete batters that can be placed into a cooking or baking environment without additional preparation steps on the part of the consumer (for example, such as addition of essential ingredients to the batter compositions, and/or additional mixing or combining steps, and the like). In some aspects, the inventive batter compositions can possess water activities comparable to conventional batters, for example, in the range of 0.94 or less, or 0.9 or less, or 0.85 or less.

As used herein, discussion of the density of the batter composition (the “uncooked density”) will refer to the density of the batter composition after it has been mixed. The density of the batter composition is typically measured prior to baking, and can be measured either prior to placement in a storage environment (such as refrigerated conditions), or after being taken from storage conditions and allowed to increase in temperature from the storage temperature. In contrast, the “baked specific volume” or “cooked specific volume” refers to the specific volume of the product after it has been baked or cooked, for example, to provide a muffin or cake.

The inventive batter compositions can be stored at refrigeration and/or ambient temperatures. Reference to the general phrase “storage temperatures” herein will be understood to encompass both refrigeration and ambient storage conditions.

In some aspects, the batter compositions are formulated to be stored at refrigeration temperatures. The inventive batter compositions are capable of maintaining desirable color, viscosity and/or uncooked density at refrigerated temperatures (that is, temperatures in the range of about 30° F. (−1° C.) to about ambient temperature, or in the range of about 35° F. (1° C.) to about 45° F. (7° C.), or in the range of about 38° F. (3° C.) to about 42° F. (5° C.)) for the time periods as set forth below.

In some aspects, the batter compositions are stable for at least 45 days, or at least 60 days, or at least 90 days, or at least 120 days, or at least 180 days when stored under refrigerated or ambient conditions. In some aspects, the batter compositions are stable for about 6 months at refrigerated temperatures. Storage temperature may vary throughout storage time. In these aspects, “stable” refers to a batter composition that is capable of withstanding at least one refrigeration/thaw cycle, wherein a refrigeration/thaw cycle comprises a temperature fluctuation of the batter composition between about 32° F. and about 50° F. The stable batter compositions are suitable for storage at refrigerated temperatures for the time periods as indicated above without the batter composition breaking down by, for example, undesirable color change, microbial growth, separation of the liquid phase, failure of the leavening agent(s), and the like, and becoming undesirable and/or unsuitable for consumption.

After being stored (for example, at refrigerated or ambient temperatures), batter compositions of the invention can be immediately placed in a cooking environment for cooking without an intervening period of time to allow the batter compositions to increase in temperature (for example, to ambient temperatures or higher). Optionally, the batter compositions can be maintained at ambient temperatures prior to placement in a cooking environment without risk of spoilage of the product. It will be understood that cooking temperatures are generally temperatures that are elevated relative to ambient temperatures, for example, 150° F. or greater, or 200° F. or greater, or 300° F. or greater. The cooking temperature will vary, depending upon the final product to be prepared. For example, for muffins, the cooking environment is an oven, and the cooking temperature is typically about 350° F. to about 400° F. For pancakes and waffles, the cooking environment is a griddle or other hot surface, and the cooking temperatures are typically about 375° F. Suitable cooking temperatures will depend a great deal on the oven (or other cooking environment) characteristics, the size (volume and/or dimensions) of the batter composition to be cooked, and cooking pan characteristics.

Further, in aspects where the batter compositions will be prepared by microwave cooking, it is understood that the cooking environment can be maintained at or about room temperature, while the batter composition itself is heated to an elevated cooking temperature (for example, up to about 200° F.).

The inventive batter compositions include a flour replacement ingredient comprising native starch and a protein source, and optionally, modified starch (in a minor amount), fiber source, or a combination of these. In addition to the flour replacement ingredient, the inventive batter compositions include conventional batter ingredients, that is, at least sweetener, a fat source, and water.

### Flour Replacement Ingredient

According to the invention, the batter compositions include a flour replacement ingredient that replaces the conventional grain constituent of typical batters. The flour replacement ingredient thus contributes to the structure of the batter composition. Thus, in accordance with aspects of the invention, batter compositions are provided that comprise typical batter ingredients wherein the traditional wheat flour has been substituted by a structure-providing amount of a flour replacement ingredient. It will be appreciated that regular flour can be included in an amount sufficiently small so as to not adversely impact shelf stability. Flour can be included in minor amounts, for example, for organoleptic purposes. In some embodiments, flour can be present in an amount of 5% or less.

The inventive flour replacement ingredient comprises native starch and protein, and optionally, modified starch and/or fiber according to the proportion of the flour replacement ingredient. Useful native starch includes, but is not limited to, wheat starch, corn starch, potato starch, tapioca starch or a combination of any of these. In accordance with the invention, native starch is the major component of the flour replacement ingredient, comprising 70% by weight or more, or 75% by weight or more, or 80% by weight or more, of the flour replacement ingredient. It has been found that when native starch is included as the major component of the flour replacement ingredient, resulting baked or cooked products possess a desirable cell structure, for example, fine, even and sponge cake-like structure and desirable color (e.g., having minimal color change).

As used herein, “native starch” refers to starch recovered in the original form (i.e., unmodified) by extraction from any starch-bearing material. Native starch can be contrasted to modified starch, which has undergone physical or chemical modification.

Optionally, a minor amount of modified starch can be included in the flour replacement ingredient. Modified starch can be included, for example, to modify the viscosity of the overall batter composition. Typically, the amount of modified starch included in the flour replacement ingredient is on the order of 25% or less, or 20% or less, or 15% or less, or 10% or less, or 5% or less, based on weight of the flour replacement ingredient. In other aspects, the modified starch can be present in the flour replacement ingredient in an amount of 5% or less, or 4% or less, or 3% or less, or 2% or less or 1% or less by weight, based on total weight of the batter composition. As used herein, “modified starch” means that the structure of starch has been modified chemically, thermally, or by other means developed in the future. Such modification can be performed to alter the viscosity of starch in water. One type of modification is gelatinization (thereby forming pregelatinized starch). Gelatinization is the process of disrupting the physical structure within the starch granule as it is heated in the presence of water. During the gelatinization process, the viscosity is increased by the granules absorbing water and swelling.

In some aspects, the invention provides the ability to formulate batter compositions to provide a desired viscosity. Thus, batter formulations possessing a viscosity profile that allow the product to be pourable from a container can be provided. Flowable batters would be characterized by not having a yield stress value, and being able to flow under their own weight. The rate at which the batter flows would be related to the temperature, force applied, and the product response to the applied force. In other aspects, batter formulations could be designed to be generally non-flowable. These batters would possess a yield stress value, which, after a force of this value being applied to the batter, will allow this batter to flow. The rate of flow will be dependent on the temperature, the force, and how the product formula responds to the force applied. In an illustrative embodiment, cake batter comprising 100% native starch as the flour replacement ingredient was formulated to provide a flowable batter composition. When the flour replacement ingredient was altered to comprise 90% native starch and 10% modified (pregel) starch, the consistency of the batter was observed to resemble the consistency of a cookie dough or brownie batter. This adjustable viscosity feature of the invention can provide enhanced flexibility in formulation and packaging, such that a wide variety of batter products can be provided to a consumer.

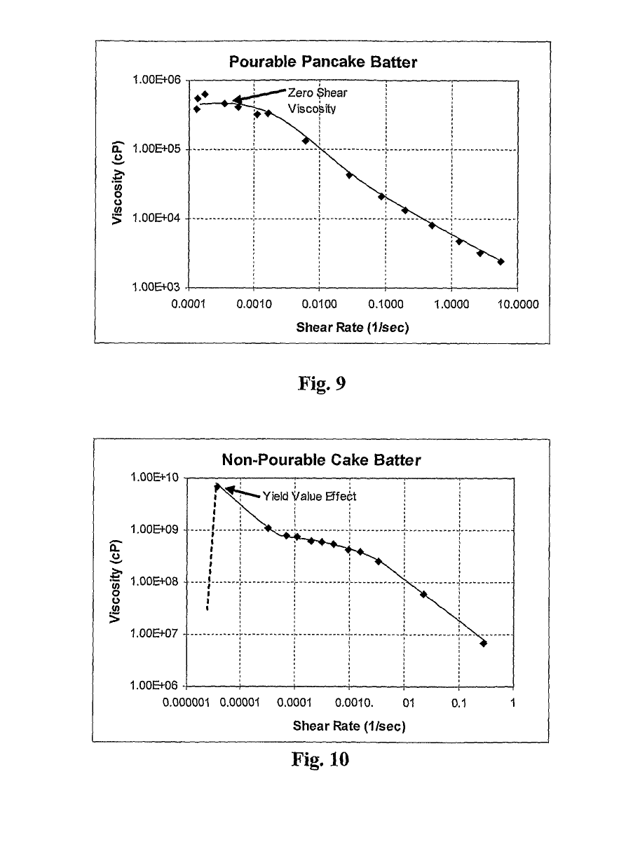

An illustrative example of the difference between a flowable and non-flowable batter is illustrated in FIGS. 9 and 10. FIG. 9 illustrates a batter with a zero shear viscosity (i.e., viscosity does not change with shear rate), so it will flow from a container and will flow under its own weight when a sample is placed on a horizontal surface. Viscosities greater than the values illustrated will still be “flowable” as long as a zero shear viscosity and no yield value are identified, although the batter may flow more slowly. FIG. 10 illustrates a non-flowable batter. As can be seen, a yield value clearly exists where a certain force must be applied before the product will start to flow. The overall viscosity range is generally higher than a liquid-like flowable batter, but does not necessarily have to be. Thus, the shape of the viscosity-shear rate curve is important in determining how the batter may flow.

Measurements in FIGS. 9 and 10 were made using a Haake RS100 controlled stress rheometer. The rheometer was set up with a parallel plate measuring head. Operation of the rheometer and data collection were controlled via software in a PC. The control software was programmed to apply increasing shear stresses to the sample over a specified range in twenty steps. The shear rate at each stress was recorded at each stress step. Viscosity is defined as shear stress/shear rate. This allowed the viscosity to be calculated and plotted as a function of shear rate.

The base plate of the measuring head was temperature controlled by a recirculating water bath. Pancake batter temperature was 70° F., and the cake batter temperature was 45° F.

As illustrated, the viscosities of the two samples were very different. This required separate programs for each of the two samples to optimize the measurements. The program details for each sample are outlined below.

### Pancake Batter: Sensor Diameter 60 mm

Gap set to 1 mm
Stress range, 0.01-020 Pascals
Programmed to run 20 steps in a logarithmic progression
30 second run time at each step

### Cake Log Batter: Sensor Diameter 20 mm

Gap set to 1 mm
Stress range, 5-10,000 Pascals
Programmed to run 20 steps in a logarithmic progression
30 second run time at each step

In some aspects, the batter composition is formulated such that it is capable of being extruded. This is in direct contrast to prior batter compositions that cannot be extruded because the compositions do not possess sufficient viscosity to be extruded.

In accordance with the invention, the adjustable viscosity of the batter compositions, by virtue of the flour replacement ingredient, can provide the ability to formulate a batter composition with sufficient viscosity to be extruded. In some aspects, the batter compositions described herein can be extruded using any appropriate extruder typically utilized for extruding dough. Extruders generally involve one or more screws that are rotated to propel dough toward a die. The extruder does not necessarily need a screw, and other implements such as paddles can be used to move the dough and to force the dough through the die under pressure.

The batter product pieces can either be filled or unfilled. In some embodiments, the extruder is fitted with a filling pump, such that batter composition reaching the die surrounds a filling and forms a coextrusion. Coextrusion is well known in the art. The relative amount of filling and batter-like composition can be adjusted by the relative speed of the extruder screw and the flow rate of the filling. When a filling is used, the batter composition surrounding the filling exits from the die during the extrusion process. The shape and size of the batter product piece depends on the shape and size of the die. The filled batter product piece can be cut or otherwise separated to a desired length. Once cut, the batter product piece can optionally be secured, for example by crimping, at one or both ends. Preferably the batter product piece is secured at both ends to seal the filling within the batter product piece.

In still further embodiments, the invention contemplates a composition that is composed of two or more batter compositions that are co-extruded. In some aspects, the batter product pieces can be formed using extrusion dies conventionally utilized for extruding dough. One such extrusion die is described in U.S. Pat. No. 5,620,713 (Rasmussen, Apr. 15, 1997). As described therein, a die can include an inner die and an outer die. The inner die is formed in a desired shape that represents an item of interest, such as an animal, toy, or other identifiable object, and the outer die has an opening surrounding the inner die. The batter composition can be extruded through each of the dies simultaneously. The batter composition for the inner die can have a different indicia, such as color or other visually identifiable characteristic from the batter composition extruded through the outer die.

The batter compositions can be extruded through any suitable extrusion equipment, for example, using a Rheon or Vemag extruder, a former, or a pump.

In accordance with the invention, the flour replacement ingredient further includes a protein source. Suitable protein sources include, for example, gluten, wheat protein, vegetable protein, sodium caseinate, or gelatin, as well as dairy proteins such as milk protein, whey protein and the like. In some aspects, the protein source can provide desirable features to the batter composition, for example, enhanced nutritional value.

The protein source can be present in an amount of 30° % by weight or less, or 20% by weight or less, or 15% by weight or less, based on total weight of the flour replacement ingredient. In some aspects, the protein source can be present in an amount of about 8% by weight or less, or 7% or less, or 6% or less, or 5% or less, or 3% or less, based on total weight of the overall batter composition.

It will be readily appreciated that batter compositions can often include protein from other sources (i.e., from sources apart from the flour replacement ingredient). For example, protein can be included in batters generally in the form of dairy protein, egg protein, wheat protein, or combinations thereof. Illustrative dairy proteins include whey, soy protein, caseinate, buttermilk, milk solids, buttermilk solids, and nonfat dry milk. Illustrative egg proteins include albumin. The egg component can be present as liquid eggs, typically pasteurized liquid eggs or frozen whole eggs. The pasteurized liquid eggs or frozen whole eggs can provide desirable structuring, emulsification, and/or nutritional benefits to the inventive batter compositions. Pasteurized liquid eggs can also provide at least a portion of the total moisture of the batter compositions. Useful amounts of liquid eggs include up to about 30% by weight (based upon the total weight of the batter composition), or in the range of about 1% to about 20%, or about 5% to about 18%. It will be appreciated that liquid eggs comprise about 75% moisture. In some embodiments, the liquid eggs can be replaced in whole or in part with dried eggs solids, or egg fractions in solid form (for example, egg yolk solids and egg white solids). Illustrative wheat proteins include those derived from flour or gluten. In some aspects, the additional protein is selected from caseinate, albumin, whey protein concentrate, nonfat dry milk, buttermilk, or a combination of any two or more of these.

Thus, in some aspects, the invention provides batter compositions including a flour replacement ingredient as described herein, wherein the flour replacement ingredient includes a protein source in an amount of 8% by weight or less, or 7% or less, or 6% or less, or 5% or less, or 3% or less, based on total weight of the overall batter composition. The batter composition can include protein from other sources, for example, in an amount up to about 50% by weight (for example, in angel food cakes), or up to about 40% by weight, or up to 30% by weight, or up to 20% by weight, or up to 10% by weight, based upon total weight of the batter composition. In these aspects, then, the total protein content of the batter compositions (including protein from the flour replacement ingredient and other protein sources external to the flour replacement ingredient) can be up to about 60% by weight, based upon total weight of the batter formulation.

Optionally, the flour replacement ingredient can include a fiber source. Useful fiber sources include, for example, wheat fiber, gum, vegetable gums such as alginates, carrageenan, dextran, furcellaran, pectin, gum agar, locust bean gum, gum ghatti, guar gum, gum tragacanth, acacia, gum arabic, xanthan gum, karaya gum, tara gum, cellulose derivatives; soluble and insoluble dietary fiber, wood pulp cellulose, seed husks, oat hulls, citrus fiber, pea fiber, corn bran, soy polysaccharide, oat bran, wheat bran, barley, rice bran, gellan gum.

When included, the fiber source can be present in an amount of 20% by weight or less, or 15% by weight or less, or 10% by weight or less, or 5% by weight or less, based on weight of the flour replacement ingredient. Although the fiber does not make a significant contribution to baked or cooked good performance, fiber can be included for nutritious purposes and/or to provide improved organoleptic properties to the baked or cooked good. In some aspects, the fiber source can be present in an amount of 5% or less by weight, or 4% or less, or 3% or less, based on total weight of the overall batter composition.

In some aspects, the flour replacement ingredient is designed to significantly reduce the enzymes naturally present in conventional flour. Such reduction of enzymes in the structure-providing component of the batter compositions can provide one or more benefits over known farinaceous batter compositions. For example, utilization of the inventive flour replacement ingredient can: reduce or eliminate enzymatic browning, which causes batter darkening and discoloration over shelf life; control batter viscosity, which can simplify the process of preparing and packaging the batter composition; prolong shelf life of the batter (for example, providing shelf life of up to 6 months at refrigerated temperatures and 6 months or longer at ambient temperatures); and/or improve stability of the batter over time.

One class of enzymes naturally present in flour and implicated in batter discoloration is polyphenol oxidases (PPOs). Another class of enzymes naturally present in flour is amylase. Amylases are enzymes that are capable of hydrolyzing starch into dextrins and maltose. As the starch component of the inventive compositions contributes to the structure of the batter compositions, amylase activity can result in batter thinning and viscosity loss over the storage life of the batter.

In accordance with some aspects of the invention, utilization of the flour replacement ingredient significantly reduces the amount of PPOs present in the batter composition. In some aspects, utilization of the flour replacement ingredient significantly reduces the amount of amylase in the batter composition. The level of PPOs and/or amylase present in a batter composition can be determined, for example, by observing enzyme activity of PPOs and/or amylase directly. Amylase activity can be measured, for example, utilizing the American Association of Cereal Chemists (AACC) Method 56-81B.

PPO activity can be measured in flour or batter. In one illustrative method, PPO activity is measured in flour and is based upon AACC Method 22-85 (measurement of PPO in wheat kernels). Generally, this method is a colorimetric method for the semi-quantitative determination of PPO in flour. The sample is treated with a solution of MOPS/L-DOPA. PPO (in the presence of oxygen) reacts with the L-DOPA in MPOS to produce a red colored solution. The intensity of the color of the solution is proportional to the amount of PPO present. This intensity is quantified and reported as a relative absorbance at 475 nm. A brief discussion of a suitable PPO assay will now be provided.

Reagents: 3-(N-Morpholino)propanesulfonic acid (MOPS), pH 6.5; L-3,4 Dihydroxyphenylalanine (L-DOPA); polyoxyethylenesorbitan monolaurate (Tween-20).

To prepare L-DOPA solution (10 mM L-DOPA/50 mM MOPS): Place a 2-inch stir bar in a 250 mL low actinic Erlenmeyer flask. Fill the flask with approximately 200 mL of deionized water. Weigh 2.6134 grams MOPS into weigh boat and transfer, with rinsing, into the flask. Quickly weigh 0.4935 grams L-DOPA and transfer into the same flask. Stopper the flask to shield the solution from light. Stir the mixture until dissolved (approximately 3½ hours). Adjust the pH to 6.47-6.50 with 1 M sodium hydroxide. Do not exceed pH=6.50. Quantitatively transfer solution into a low actinic 250 mL volumetric flask and bring to volume with deionized water. This solution expires the day of preparation and must be prepared fresh daily.

Method: Flour samples are removed from storage and warmed to room temperature. 1 g of sample is weighed into a 2 mL centrifuge tube. Exact weight of the sample is recorded to the nearest 0.01 g. Dispense 1.5 mL of the L-DOPA solution into each centrifuge tube and vortex the tube for 2-3 seconds to ensure dispersion of the sample in solution. Rotate the centrifuge tube on a RotoGenie Shaker at a setting of 1 for 60 minutes (or an equivalent centrifuge for equivalent speed and time) to ensure the head space migrates throughout the entire sample. Next, centrifuge the tube at approximately 14000 RPM for 5 minutes. Absorption of the sample is read at 475 nm directly from centrifuge tubes. The enzyme activity of PPO is reported as a net absorbance at 475 nm normalized to the mass of the sample by dividing the net absorbance by mass of the sample. The quantity is multiplied by a correction factor of 0.1.

Another method of determining PPO and/or amylase activity within a flour or batter sample is to measure an indicator enzyme. While many different enzymes are present in wheat grain, enzyme levels of wheat grain and wheat grain constituents are often measured in terms of the enzyme peroxidase. Peroxidase is only one of the many enzymes typically present in a wheat material, and may not be the most important enzyme with respect to retained freshness of a batter product prepared from a wheat material. Peroxidase, however, may be reliably measured by analytical techniques such as described herein. As such, when measuring the amount of enzymes of flour replacement ingredients and batter compositions, for example, according to methods of the invention, an indication of peroxidase activity can also be an indication that other less heat-stable enzymes have been eliminated from the batter compositions, such as, for example, amylase and/or PPOs.

A typical amount of peroxidase that may be found in wheat grain (for example, a kernel or other wheat material that contains naturally occurring proportions of endosperm, germ, and bran) can be in the range of about 4000 to about 6000 units of active peroxidase per gram (U/g) wheat grain. For example, about 4600 to about 5000 units of active peroxidase per gram, often about 4800 units of active peroxidase per gram (for example, on an “as is” moisture basis).

The amount of enzyme reduction that can be accomplished according to aspects of the invention can be an amount that improves shelf life of a batter composition, reduce color change of the batter composition over storage, and/or reduce viscosity change of the batter composition over storage. Exemplary reduction of enzyme can be at least 30% reduction of the total amount of enzyme activity of the batter composition, or at least 50% reduction or at least 75% or at least 80% or at least 90% or at least 95% reduction of enzyme activity in the batter composition, as compared to batter compositions formulated with conventional flour.

In accordance with some aspects, the inventive batter compositions can provide reduction of a selected enzyme (e.g., PPO, amylase or peroxidase) of at least 30% reduction of the enzyme activity of the batter composition, or at least 50% reduction or at least 75% or at least 80% or at least 90% or at least 95% reduction of enzyme activity in the batter composition, as compared to batter compositions formulated with conventional flour.

In accordance with some aspects of the invention, batter compositions can be formulated to possess peroxidase activity of 50 units/gram or less.

An illustrative method of measuring peroxidase is as follows. The method is based on the principle that peroxidase catalyzes the following reaction:

Donor+H₂O₂→oxidized donor+H₂O

Guaiacol is a suitable donor for colorimetric detection of peroxidase; the oxidized form (tetraguaiacol) is highly colored with an absorbance peak at approximately 435 nm.

Method: Peroxidase enzyme is extracted from a sample of flour replacement ingredient or batter composition using 0.015-0.020 M ammonium acetate and centrifuged. An aliquot of the supernatant is reacted with alcoholic guaiacol (10% v/v) and 3% hydrogen peroxide. The absorbance at λ=435 nm is measured; the increase in absorbance is proportional to the activity of peroxidase. Peroxidase U/g is defined as the increase in absorbance over a one-hour period (at room temperature, 22° C.-23° C. (72° F.-73° F.)) multiplied by approximately 670 and divided by the sample weight (in grams).

In accordance with the above-described procedures for enzymatic activity analysis, levels of amylase, peroxidase and PPO were measured in a flour replacement ingredient (85% native starch, 10% wheat protein isolate, 5% wheat starch) in accordance with the invention. Also, levels were measured in various conventional flours, as comparative samples. Results are shown in the following Table 1:

TABLE 1

| | | Peroxidase | Polyphenol |
|---|---|---|---|
| Sample | Alpha Amylase | Activity | Oxidase |
| Flour replacement | <0.01 Units/g | 10 Units/g | 0.007 AU*/0.1 g |
| ingredient (85% | | | |
| Native Starch, 10% | | | |
| wheat protein | | | |
| isolate, 5% wheat | | | |
| starch) | | | |
| Heat Treated Flour | 0.05 Units/g | 940 Units/g | 0.128 AU/0.1 g |
| Unchlorinated Cake | | | |
| Flour | | | |
| Low Extraction, | 0.01 Units/g | 870 Units/g | 0.061 AU/0.1 g |
| Unchlorinated Cake | | | |
| Flour | | | |
| De-branned | 0.03 Units/g | 1300 Units/g | 0.097 AU/0.1 g |
| Unchlorinated Cake | | | |
| Flour | | | |
| Chlorinated Cake | 0.03 Units/g | 470 Units/g | 0.148 AU/0.1 g |
| Flour | | | |

*AU = Absorbance units at 475 nm

Batters were also tested in accordance with the general methods described herein. Chocolate batter including flour replacement ingredient (in accordance with Table 1, with a minor amount of pregel starch included as well) in accordance with the invention had ⅓ the peroxidase activity, and ¼ of the polyphenyl oxidase activity of a commercially available refrigerated cake batter that was made with wheat flour.

In some aspects, batter compositions in accordance with the invention can be formulated to have a PPO activity of 0.1 AU/0.1 g or less.

The batter compositions typically include an amount of flour replacement ingredient effective to provide structure to the batter composition. Put another way, a batter composition includes flour replacement ingredient in an amount effective to provide desired consistency of the batter composition. Generally speaking, the amount of flour replacement ingredient should not be so high that the batter composition is dry and loses its ability to expand. However, the amount of flour replacement ingredient should not be so low that the batter composition is unsuitably soft and loses its structure as a batter composition. The inventive batter compositions generally contain, an amount of flour replacement ingredient substantially equal to, or slightly less than, the amount of flour that would be included in a conventional batter composition. To this end, the inventive batters can contain flour replacement ingredient in the range of about 12 to about 40 weight percent, or in the range of about 17 to about 35 weight percent, or in the range of about 20 to about 25 weight percent of the batter composition.

The amount of flour replacement ingredient included in a batter can be dependent upon the end product to be ultimately prepared from the batter composition. For example, in yellow cake batters, useful amounts of flour replacement ingredient can be in the range of about 17 to about 40 weight percent, or in the range of about 18 to about 35 weight percent, or in the range of about 20 to about 25 weight percent of the batter composition. In contrast, in chocolate cake batters, the presence of cocoa can dilute the flour replacement ingredient. In these cases, a lower amount of the flour replacement ingredient can be present, for example, as low as about 12 weight percent of the batter composition. Other modifications can be made to the particular amounts of flour replacement ingredient according to the particular application (e.g., cakes, pancakes, brownies, etc.), utilizing the principles described herein.

### Sweetener

According to the invention, a sweetener ingredient is included in the inventive batter compositions. The sweetener typically comprises sugar or nutritive carbohydrate sweetener ingredients. Generally, the sweetener can provide sweetness and lower the water activity (A_{w}) of the batter composition. The inventive batter compositions can include one or more sweeteners; thus, reference to the singular form will be understood to include situations where more than one sweetener is included in the inventive compositions.

In some aspects, the sweetener comprises sugar. Useful sugars include saccharides that can reduce the amount of free water in the composition. Useful sugars include monosaccharides, disaccharides, polysaccharides, sugar alcohols, and their various degradation products. Illustrative sugars include, but are not limited to, pentoses, xylose, arabinose, glucose, galactose, amylose, fructose, sorbose, lactose, maltose, dextrose, sucrose, maltodextrins, high fructose corn syrup (HFCS), molasses and brown sugar. In some embodiments, the sugar is selected from sucrose, high fructose corn syrup, and maltodextrin. Sugar alcohols that can be utilized include isomalt, lactitol, maltitol, mannitol, sorbitol, erythritol, xylitol, glycerol/glycerin, and combinations of any two or more of these.

Because the sweeteners impart sweetness to the cooked product, the kind and amount of sweetener(s) is (are) selected to achieve a balance between reducing the water activity of the batter composition a sufficient amount to provide microbial stability and obtaining the desired degree and quality of sweetness in the baked or cooked product. This can be achieved by balancing both the ratios of various sweeteners to one another and the ratios of sweeteners to water in the batter composition.

A useful amount of sweetener in a batter composition of the present invention includes an amount that provides suitable properties such as sweetness to the batter composition, and/or a desired water activity. When reference is made herein to the total amount of sweetener, such amount includes sweetener from all sources. Thus, in some aspects, the invention contemplates batter compositions having more than one type of sweetener. Such an amount of total sweeteners can be in the range of about 5% to about 55% by weight of the batter composition, or in the range of about 10% to about 40% by weight, the weight percentages based upon the total weight of the batter composition.

Another way to characterize a useful amount of sweetener in the inventive batter compositions is to observe the relative amount of sweetener to flour replacement ingredient (the flour replacement ingredient including starch (both native and modified) and protein, and optionally, fiber source and/or any additional flour added). The particular ratio of sweetener to flour replacement ingredient will depend upon various factors, such as, for example, the particular sweetener(s) employed, the final food product, desired baked or cooked good attributes, and the like. The sweetener:flour replacement ingredient ratio of the batter compositions can be in the range of about 1:1 to about 1.4:1, that is about one part sweetener to one part flour replacement ingredient, to about 1.4 parts sweetener to one part flour replacement ingredient. Maintenance of the sweetener to flour replacement ingredient ratio within these ranges can, in some aspects, be important to providing finished baked cooked goods having the desired eating qualities. In some aspects, the sweetener-to-flour replacement ingredient ratio can also impact storage stability of the inventive batter compositions.

In some embodiments, at least a portion of the sweetener can be substituted with a high potency heat tolerant sweetener. In some aspects, inclusion of the high potency sweetener can provide additional sweetness to the final baked cooked product. In some aspects of the invention, a high potency sweetener is a component that provides a sweet taste to the final product, where the component contributes no calories or where the component does contribute calories, but possesses a sweetness potency that is so high that their extremely low usage level imparts no significant impact on the final product's caloric content. In some embodiments, the high potency sweetener is selected so as not to degrade during either storage or more importantly, during the baking or cooking step. While degradation during storage and baking/cooking can be overcome by over fortifying with a high potency sweetener to compensate for the expected loss, such extra addition is costly. One illustrative high potency heat tolerant sweetener is sucralose. The sucralose can be conveniently added in a 25% solution. Good results are obtained when the sucralose is added at about 0.05% to about 0.15%. Other illustrative high potency sweeteners include polydextrose, aspartame, potassium acetylsulfame, saccharine, cyclamate, neotame, alitame, and combinations of any two or more of these.

In some aspects, at least a portion of the sweetener can comprise a high potency sweetener. In some aspects, therefore, up to 100% of the sweetener can comprise a high potency sweetener.

When the inventive compositions include one or more high potency sweeteners, the total amount of sweetener included in the composition is typically decreased. Thus, in embodiments where the compositions include high potency sweetener, the sweetener can comprise up to 40% of the total batter composition, or in the range of about 0.01% to about 40% of the batter composition. As a result, one of skill in the art will readily appreciate that bulking agents can be included to compensate for lost weight within the overall composition. Suitable bulking agents include any inert ingredients that do not impact overall textural qualities of the cooked product. Illustrative bulking agents include crude fiber that can be composed of cellulose, hemicellulose, lignin, and pectin substances; starches, flour, whey, and the like. It will be understood that any amount of bulking agent(s) added to the batter compositions for these purposes would be in addition to starch, protein and/or starch present in the flour replacement ingredient.

### Fat Source

The inventive batter compositions include an edible fat source. A fat source can add richness to the eating properties of the finished baked or cooked goods. A fat source can also impact characteristics of the batter composition (such as processability and viscosity), as well as characteristics of the final baked or cooked good (such as texture). The fat source can have beneficial effects on the volume, grain, and texture of the final product, as well as the texture, mouthfeel and/or other organoleptic properties of the baked or cooked good.

Useful fat sources include shortenings and oils. Animal or vegetable based natural shortenings can also be used, as can synthetic shortenings or oils.

Typical shortenings include fatty glyceridic materials that can be classified on the basis of their physical state at room temperature. Solid shortenings are useful and can provide the advantage of desirable mouthfeel upon consumption. In some embodiments, mixtures of liquid and solid shortenings can be utilized. Such mixes can be fluid or plastic, depending in part upon the level of solid fatty materials.

The solid fatty glycerides can include fatty mono-glycerides and diglycerides of saturated fatty acids having 4 to 22 carbon atoms. The liquid shortening can be animal, vegetable or synthetic oil (such as sucrose polyesters) that is liquid at ordinary room temperatures. Representative of such typical fat sources are palm oil, butter, lard, margarine, tallow, coconut oil, palm kernel oil, cottonseed oil, peanut oil, olive oil, sunflower seed oil, sesame seed oil, corn oil, safflower oil, poppy seed oil, soybean oil, canola (rapeseed) oil, babassue oil, and the like and combinations thereof. Other suitable shortening materials and methods of shortening preparation are described in detail in Bailey, “Industrial Oil and Fat Products,” 3^{rd} ed. 1964).

Mixtures of the oils described herein can also be used, as can solid fatty materials, such as saturated triglyceride fats. In general, such solid fatty materials can be added to liquid oil, in an amount in the range of about 1.5% to about 25% of triglycerides that are solid at 70° F.

A useful amount of total fat source in a batter composition of the present invention (from all sources) includes an amount that provides suitable properties such as organoleptic qualities and desired textural properties to the finished baked or cooked good. Such an amount can be up to about 25% of the batter composition, or in the range of about 10% to about 20% by weight. For preparation of a lower fat baked or cooked good, the batter compositions can include total fat in an amount up to about 10%, or in the range of about 1% to about 10% by weight, based upon the total weight of the batter composition. Optionally, the inventive batter compositions can include a fat-replacer, for instance, when it is desired to provide a baked or cooked product having less fat. Suitable fat-replacers can be selected to mimic the effects of the fat source in the batter composition, for example, by binding water present in the batter composition and/or providing fat-like sensory properties in the baked or cooked products. The fat-replacer can improve softness, texture, and/or mouthfeel of baked or cooked products prepared from batter compositions containing the replacer. In some embodiments, the fat-replacer can improve the strength and structure of a batter composition, reduce sugar and/or water migration to the surface of the batter composition (and intermediate products prepared therefrom), and improve yield.

One type of fat-replacer suitable in accordance with the invention is fiber. Any suitable fiber obtained from a plant source can be utilized in accordance with the invention. An illustrative fiber is citrus fiber. A commercially available citrus fiber that can be useful is Citri-Fi™ (Fiberstar, Inc., Willmar, Minn.). Again, any fiber included as a fat-replacer is in addition to a fiber source included in the flour replacement ingredient.

### Optional Leavening System

In some aspects, the inventive batter compositions can be utilized to prepare leavened or unleavened baked or cooked products. Illustrative unleavened products include, but are not limited to, unleavened breads, cakes, crepes, and the like.

When the inventive batter compositions are utilized to prepare leavened products, the batter compositions can involve any of a variety of leavening systems. Illustrative leavening systems include decomposition of heat sensitive substances into leavening gases (for example, ammonium bicarbonate NH₃HCO₃ at 60° C. will produce ammonia NH₃, water H₂O and carbon dioxide CO₂); reaction between acids or their salts with leavening bases (such as sodium bicarbonate) to produce CO₂; water vapor or steam; whipped air; or a combination of any of these.

In some aspects, the inventive batter compositions include chemical leavening systems. Chemically-leavenable (“chemically-leavened”) batter compositions are batter compositions formulated to leaven to a substantial extent by the action of chemical ingredients that react to produce a leavening gas. Typically, the ingredients of a chemical leavening system include a basic chemical leavening agent and an acidic chemical leavening agent that react together to produce carbon dioxide, which, when retained by the batter matrix, causes the batter composition to expand. Chemically-leavenable batters or dough compositions can be contrasted to batter or dough formulations that are substantially leavened due to the action of yeast as a leavening agent, that is, by metabolic action of yeast on a substrate to produce carbon dioxide. While batter compositions of the invention can include yeast, for example, as a flavoring agent, certain batter compositions of the invention do not include yeast as a leavening agent.

U.S. Pat. No. 5,405,636 (Gard et al.) describes a leavening acid comprising a mixture of dimagnesium phosphates. The leavening acid of the '636 patent comprises dimagnesium phosphate trihydrate, amorphous dimagnesium phosphate and small amounts of magnesium pyrophosphate. The dimagnesium phosphates contain from about 33 percent to about 66 percent amorphous dimagnesium phosphate. According to the '636 patent, while a small amount of leavening is contributed by the dimagnesium phosphate trihydrate, major leavening action is related to the presence of substantial amounts of the amorphous dimagnesium phosphate.

It has now been discovered that dimagnesium phosphate trihydrate can be used as the major leavening acid component in batter compositions. Contrary to the teaching of the '636 patent, it has been discovered that leavening acid consisting essentially of dimagnesium phosphate trihydrate can be utilized in combination with a leavening base in a batter composition to provide leavening capability that is comparable to, or better than, batter compositions containing the compositions described in the '636 patent.

Suitable dimagnesium phosphate trihydrate can be obtained from commercial sources, for example, from Chemische Fabrik Budenheim, KG (Budenheim, Germany, product dimagnesium phosphate, 3-hydrate, fine powder, FCC M52-81, CAS No. 7757-86-0). In some embodiments, the neutralizing value (NV) and/or particle size of the dimagnesium phosphate trihydrate can be relevant in providing acceptable leavening activity. For example, dimagnesium phosphate trihydrate having a relatively fine particle size can be particularly useful. In some aspects, the dimagnesium phosphate trihydrate has a mean particle size of 17 μm or 15 μm or less, or 10 μm or less.

In accordance with some aspects of the invention, a batter composition is provided, the batter composition comprising a structure-providing amount of flour or flour replacement ingredient; sweetener in an amount effective to provide a water activity of 0.94 or less; fat source; and a chemical leavening system, the chemical leavening system comprising a basic leavening agent and dimagnesium phosphate trihydrate as acidic leavening agent, the dimagnesium phosphate trihydrate comprising at least 75% by weight of the acidic leavening agent. In other aspects, the dimagnesium phosphate trihydrate can comprise 80% or more, or 85% or more, or 90% or more, or 95% or more, or 100% of the acidic leavening acid. In some aspects, the inventive batter compositions include less than 30% by weight, or less than 20% or less than 10% or less than 5% amorphous dimagnesium phosphate based on weight of the acidic leavening agent.

In accordance with the invention, dimagnesium phosphate trihydrate can be employed as the acid factor in leavening systems in typical application with a carbonate factor. Carbonate factors include any suitable basic materials such as sodium bicarbonate as well as other basic materials such as potassium bicarbonate, amorphous calcium carbonate, ammonium bicarbonate and the like, including those described below.

Advantageously, dimagnesium phosphate trihydrate can be utilized with unencapsulated basic chemical leavening agents. Thus, in some aspects, the invention provides batter compositions that include a leavening system comprising dimagnesium phosphate trihydrate as acidic leavening agent and an unencapsulated leavening base. In accordance with these aspects of the invention, the ability to use a leavening system that does not require encapsulated leavening agents (acidic or basic) can provide cost savings in production of the batter compositions. It has been found that use of dimagnesium phosphate trihydrate as acidic leavening agent in combination with conventional carbonate factors can provide batter compositions that reduce or avoid premature leavening of the batter prior to baking or cooking. Premature reaction of the leavening agents can produce carbon dioxide, which can in turn result in increased volume of the batter composition and increased volume of the packaging for the batter composition (i.e., package bulging). Such package bulging can be perceived as unacceptable by the consumer. Moreover, premature leavening can use up the leavening agent prior to baking/cooking, resulting in a final product that has unacceptable finished quality. In some aspects, the inventive batter compositions provide batters that exhibit heat-activated leavening. Heat-activated leavening as described in this application means that a substantial release of carbon dioxide does not occur in a batter at ambient temperature. However, substantial carbon dioxide release occurs during the baking or cooking operation thereby providing the baked or cooked product with desirable texture. As illustrated in the examples, some embodiments of the invention can provide batter compositions that have a lower pouch volume relative to batter compositions prepared with conventional encapsulated leavening agents, illustrating the reduced carbon dioxide generation in the inventive batter compositions relative to conventional batters. In addition, the examples illustrate some embodiments of the inventive batter compositions that can provide baked or cooked products having a baked/cooked height that is superior to baked or cooked products prepared with encapsulated conventional chemical leavening agents.

Basic chemical leavening agents are generally known in the baking arts, and any chemical leavening base that is capable of undergoing a reaction with a chemical leavening acid is suitable for use in the batter compositions of the invention. A basic agent may be encapsulated or non-encapsulated. Both encapsulated and non-encapsulated basic chemical leavening agents are generally known and commercially available, and can be prepared by methods known in the baking and encapsulation arts.

As a result, only the exemplary chemical leavening bases, namely sodium bicarbonate (baking soda), ammonium carbonate, ammonium bicarbonate, and potassium bicarbonate, are recited herein. In some aspects, baking soda can serve as the primary source of carbon dioxide gas in many chemical leavening systems.

In accordance with some aspects of the invention, dimagnesium phosphate trihydrate provides the major leavening activity of the acidic component of the leavening system. In these aspects, dimagnesium phosphate trihydrate can retain leavening capacity for a prolonged shelf life as compared to conventional acidic leavening agents.

In other aspects of the invention, the major leavening activity of the acidic component can be provided by: (1) dimagnesium phosphate trihydrate in combination with dicalcium phosphate, or (2) dicalcium phosphate alone, or (3) dicalcium phosphate in combination with SALP. In these aspects, the invention provides batter compositions comprising a structure-providing amount of flour or flour replacement ingredient; sweetener in an amount effective to provide a water activity of 0.94 or less; fat source; and a chemical leavening system, the chemical leavening system comprising a basic leavening agent and a major acidic leavening agent selected from: (a) dimagneisum phosphate trihydrate in combination with dicalcium phosphate, or (b) dicalcium phosphate alone, or (c) dicalcium phosphate in combination with SALP, wherein the major acidic leavening agent comprises at least 75% by weight of the acidic leavening agent. In other aspects, the major acidic leavening agent can comprise 80% or more, or 85% or more, or 90% or more, or 95% or more, or 100% of the acidic leavening acid.

In accordance with the invention, when acidic leavening agents are included in addition to the major acidic leavening agent, these agents are typically included in minor amounts. The relative amounts of leavening acids, and relative amounts of acidic leavening agents to basic leavening agents, can be calculated based upon the neutralizing value (NV). The NV is calculated by dividing the carbon dioxide carrier by the amount of leavening acid needed for neutralization. The NV calculation can be represented by the following formula:

$$NV = \frac{sodium bicarbonate}{leavening acid} \times 100$$

Below are illustrative amounts of carbon dioxide carriers, leavening acids, and neutralizing values for various cooked product types.

| | Sodium Bicarbonate | Leavening |
|---|---|---|
| Product type | % Flour or Starch Base | Acids |
| Sponge Cake | 1.0-1.5 | SAPP, SALP, MCPM |
| Aerated Batter | 0.6-0.8 | SAPP, MCPM, |
| | | Baking Powder |
| Waffle | 0.3-0.8 | SAPP |
| Stolen | 1.0-2.0 | SAPP |
| Muffin | 1.6-2.5 | SAPP, Baking powder |
| Pancakes | 1.6-2.0 | SALP, SAPP |
| Layer cake | 0.7-1.0 | SAPP, SALP |
| Angel cake | 1.6-2.0 | SAPP, SALP, Fumaric, |
| | | MCPM |
| Ready to Cook | 0.1-2.0 | DMP, DCPD |
| Batters in | | |
| accordance with the | | |
| invention | | |

Acidic chemical leavening agents are generally known in the baking arts, with examples including sodium aluminum phosphate (SALP), sodium acid pyrophosphate (SAPP), monosodium phosphate, monocalcium phosphate monohydrate (MCP), anhydrous monocalcium phosphate (AMCP), dicalcium phosphate dihydrate (DCPD), dicalcium phosphate (DCP), sodium aluminum sulfate (SAS), glucono-delta-lactone (GDL), potassium hydrogen tartrate (cream of tartar) as well as a variety of others, and combinations of any of these. Commercially available acidic chemical leavening agents include those sold under the trade names: Levn-Lite® (SALP), Pan-O-Lite® (SALP+MCP), STABIL-9® (SALP+AMCP), PY-RAN® (AMCP), and HT® MCP (MCP). Acidic chemical leavening agents come in a variety of solubilities at different temperature ranges, and may be either encapsulated or non-encapsulated. An illustrative leavening system includes sodium aluminum phosphate and baking soda.

The chemical leavening agents can be present in an amount that provides one or more useful properties as described herein, including stability at refrigeration and/or frozen temperatures, desired refrigerated and/or frozen uncooked specific volume, and desired baked or cooked leavening properties following refrigerated and/or ambient storage. For example, the leavening system can make up about 5% by weight of the batter composition, or in the range of about 0.4% to about 1% by weight of the batter composition, and the relative amount of leavening acid to leavening base can be selected taking into consideration the NV as discussed herein. Illustrative NV for sodium bicarbonate are shown below:

| NV for Sodium Bicarbonate | Leavening Acid |
|---|---|
| SAPP | 73 |
| MCPM | 80 |
| SALP | 100 |
| DCPD | 33 |
| DMP3H* | 40 |

In some aspects, the amount of chemical leavening system can be included to provide a uncooked density in the range of about 0.4 g/cc to about 1.3 g/cc, or in the range of about 0.65 g/ec to about 1.2 g/cc, or about 0.8 g/cc to about 1.2 g/cc during refrigerated and/or ambient storage, as well as a desired cooked specific volume upon baking or cooking, such as a baked/cooked specific volume in the range of about 2.5 cc/g to about 5.0 cc/g.

As discussed supra, the chemical leavening systems in accordance with aspects of the invention can be formulated such that encapsulation of the acidic leavening agent and/or basic leavening agent is not required. However, in some embodiments, one or more of the chemical leavening agents of the leavening system can be encapsulated. (As used throughout this description and claims, unless otherwise noted, amounts of chemical leavening agents and encapsulated chemical leavening agents are given in terms of the amount of active leavening agent not including the weight of any encapsulant or barrier material). Illustrative encapsulated chemical leavening agents and encapsulation techniques are described, for example, in U.S. Publication No. 2003/0049358 A1 (“Chemical Leavened Doughs and Related Methods,” Domingues, published Mar. 13, 2003).

Encapsulated basic chemical leavening agents are generally known, and can be prepared by methods known in the baking and encapsulation arts. An example of a method for producing enrobed particles is the use of a fluidized bed.

Encapsulated basic chemical leavening agents are typically particles that include solid basic chemical leavening agent particulates covered in part, for example, substantially completely, by a barrier material or encapsulant. Encapsulated particles are known in the baking arts, and include encapsulated particles sometimes referred to as “enrobed” particles, as well as those sometimes referred to as “agglomerated” particles. The barrier material or encapsulant forms a coating or shell around a single or multiple particulates of solid basic chemical leavening agent, separating the chemical leavening agent from a bulk dough composition. “Enrobed” particles generally include a single particulate of chemical leavening agent covered or coated by barrier material, and “agglomerate” particles generally include 2, 3, or more particulates of chemical leavening agent contained in a mass of barrier material.

Encapsulating the basic chemical leavening agent provides separation between the basic chemical leavening agent and the bulk of the batter composition to inhibit, prevent, or slow the progress of reaction of the basic and acidic leavening agents. On the other hand, due to cracks, incomplete coverage, or damage to encapsulated particles, some amount of basic agent can be exposed, allowing it to dissolve into a batter composition, contact leavening acid, and react to produce carbon dioxide. Due to such imperfect encapsulation, acidic leavening agent can react with an amount of exposed basic leavening agent during refrigerated or ambient storage, to produce carbon dioxide gas that can expand the batter composition.

An encapsulated basic chemical leavening agent may be selected based on its degree of encapsulation or “activity.” “Activity” refers to the percentage by weight of basic chemical leavening agent that is contained in encapsulated particles based on the total weight of the particles. A useful degree of encapsulation or activity can be an activity that allows a desired amount of basic agent to be released from encapsulation prior to baking or cooking, to result in desired stored and baked/cooked dough properties. According to embodiments of the invention, an encapsulated basic chemical leavening agent can have any useful activity, with activities in the range from 50 to 90 percent, for example, 70 to 80 percent, being exemplary.

### Minor Ingredients

Optionally, the inventive batter compositions can include a variety of additional minor ingredients or “conventional additives” suitable for rendering finished baked/cooked goods prepared therefrom more organoleptically desirable. In some aspects, the inventive batter compositions can include an emulsifier component. The emulsifier component can include one or more emulsifiers. Emulsifiers can be nonionic, anionic, and/or cationic surfactants that can influence the texture and homogeneity of the batter composition, and/or improve eating quality of the finished product. In some aspects, when the fat source is a shortening, such shortening component provides a convenient carrier for addition of emulsifiers to the batter composition. Such emulsifiers can aid the realization of baked or cooked goods with improved grain structure and texture. The emulsifier can also be useful to maintain the emulsion integrity of the batter composition over extended storage (such as extended room temperature storage).

All or a portion of the emulsifier component can be admixed with the shortening component. Some emulsifier(s), such as monoglycerides, have relatively higher melting points than the shortening component. Consequently, as more emulsifier is added to the shortening component to form an emulsified shortening component, its melting point and hardness increases. As the increased emulsifier levels “harden” the shortening component, blending with other ingredients of the batter composition can become more difficult. Thus, in some embodiments, a first portion of the emulsifier can be preblended with the fat source, a second portion can be added in its dry powder form, while a third portion can be admixed in liquid form.

The emulsifier typically comprises up to about 25% of the shortening component, or about 5% to about 15%, or about 10% to about 15%, or about 15% to about 25% of the fat source. When preblended with the shortening component to form an emulsion, the emulsion can contain at least about 2% to about 10% by weight of the fat source of the emulsifier, or about 3% to about 5% of the emulsifier. In further aspects, the amount of emulsifier in the batter composition can be in the range of about 0.3% to about 10%. In one illustrative embodiment, wherein the batter compositions are utilized to provide muffin products, the batter composition can include the emulsion in an amount of about 25%, wherein 44% of the emulsion comprises a fat source (based upon the weight of the emulsion), and 14% of the emulsion comprises emulsifier (based upon the weight of the emulsion).

Emulsifiers can be prehydrated in an aqueous dispersion and added to the batter composition. They can also be part of an emulsion or dispersion with or without a fat source. Generally useful as emulsifiers are partially esterified polyhydric compounds having surface-active properties. This class of emulsifiers includes among others, mono- and diglycerides of fatty acids, such as monopalmitin, monostearin, monoolein, and dipalmitin; partial fatty esters of glycols, such as propylene glycol monostearate and monobehenate; glyceryl-lacto esters of fatty acids; ethoxylated mono- and diglycerides; higher fatty acid esters of sugars, such as the partial palmitic and oleic acid esters of sucrose; phosphoric and sulfuric acid esters, such as dodecyl-glyceryl ether sulfate and monostearin phosphate; and diacetylated tartaric esters of monoglyceride (DATEM). Other examples include the partial esters of hydroxycarboxylic acids, such as lactic, citric, and tartaric acids with polyhydric compounds, for example, glycerol lacto-palmitate, and the polyoxyethylene ethers of fatty esters of polyhydric alcohols, such as a polyoxyethylene ether of sorbitan monostearate or distearate. Fatty acids alone or esterified with a hydroxy carboxylic acid, for example stearoyl-2-lactylate, are also useful.

The total amount of emulsifier(s) in the batter compositions can be adjusted such that suitable organoleptic properties are obtained. That is, the total level of emulsifiers in the batter compositions can be adjusted such that the final baked or cooked goods prepared from the inventive batter compositions have a rich mouthfeel, a smooth texture and a baked/cooked specific volume as described herein. Some illustrative baked/cooked specific volumes include about 0.2 g/cc to about 0.4 g/cc (for pancakes); about 0.3 g/cc to about 0.6 g/cc (for cakes); and other appropriate cooked specific volumes based upon the final baked or cooked good to be prepared.

In some embodiments, the emulsion is provided by prepared water-in-oil (w/o) emulsions, such as butter or margarine. Typically, these emulsions are commercially available and include some emulsifier. In some aspects, the w/o emulsion is a high-moisture emulsion, to achieve the beneficial features of the emulsion discussed herein. In some aspects, the high-moisture emulsion includes a water:fat ratio in the range of 90:10 to 60:40. In some aspects, most, but not all, water present in the batter compositions described herein is bound in the emulsion (as described above). One commercially available w/o emulsion found useful in the present invention is a high-moisture margarine, such as commercially available from Unilever under the product name Promise Lite™. In some aspects, the w/o emulsion is added in solid form during formulation of the batter composition.

Additional optional batter components include anti-oxidants, salt, coloring agents, flavoring agents, preservatives, spices, flavor chips, and particulates (such as nuts, fruit pieces, and other edible inclusions). Flavor chips can include chocolate, mint chocolate, butterscotch, peanut butter chips, and mixtures thereof. The flavor chips can be coated with a topical film to minimize moisture migration such as with a hard fat or with edible shellac. Inclusions can include berries, nuts, and the like. If present, such optional components collectively comprise about 1% to about 15% of the batter composition.

An antimycotic agent can optionally be incorporated in the batter composition to enhance microbial stability. Useful agents include sorbic acid and its derivatives such as sodium or potassium sorbate, propionic acid and its derivatives, vinegar, sodium diacetate, monocalcium phosphate, lactic acid, citric acid, and the like. These agents can be present in an amount effective to inhibit the growth of undesirable microbes such as yeasts and/or molds. When present, the antimycotic agent(s) can be included in an amount up to about 0.2% by weight, or in the range of about 0.1% to about 0.2% by weight. The amount included will typically be selected to provide an antimycotic effect, while avoiding or minimizing any noticeable off-taste to the batter composition.

One illustrative minor ingredient is calcium acetate. Calcium acetate can be employed as a thickening agent, texture modifier, a preservative, and/or as a buffer for pH.

In some aspects, for example, when the batter compositions are formulated for refrigerated storage conditions, the compositions can include preservatives, such as anti-microbial agents commonly used in dough and/or batter formulation.

### Batter Composition—Characterization

In some aspects, the batter compositions can have a total moisture content comparable to that of conventional batters. The total moisture content includes water provided with or associated with the various essential and optional ingredients. For example, total moisture includes the moisture associated with the flour replacement ingredient, cocoa and especially liquid eggs. The total moisture can be easily determined by vacuum oven drying of the batter compositions herein.

The particular selection of ingredients and concentrations are selected to provide batter compositions having a water activity comparable to conventional batters. As described herein, water activity can impact the shelf life of batter compositions. By measuring water activity, it is possible to predict which microorganisms will and will not be potential sources of spoilage. Water activity determines the lower limit of available water for microbial growth. In addition to influencing microbial spoilage, water activity can play a significant role in determining the activity of enzymes and vitamins in foods and can have an impact on the food's color, taste, and/or aroma.

Generally speaking, the pH level of batter compositions can impact stability, leavening capacity, color, and/or flavor of the compositions as well. In some embodiments, the inventive batter compositions can have a pH that is comparable to conventional batters.

In some aspects, the inventive batter compositions can provide advantages over known or conventional batters, in that the pH levels of the batter compositions can be approximately neutral. In some embodiments, batter compositions in accordance with the invention can have a pH of 6.5 or greater, or 7.0 or greater. In some embodiments, inventive batter compositions can have a pH in the range of about 6.5 to about 8, or about 6.5 to about 7.5, or about 7. In these embodiments, the batter compositions are not required to be acidic in order to provide shelf-stability, microbial stability and/or color stability. This can be advantageous, as it can minimize or avoid addition of ingredients, such as acids to adjust the pH level to acidic.

In accordance with some aspects of the invention, the batter compositions can provide an adjustable viscosity. Thus, the batter compositions can be formulated to provide viscosities that can range from pourable to relatively non-pourable. In some embodiments, the batter compositions can provide a relatively less viscous batter when it is desirable to pour the batter into a baking pan or a microwavable container. In some embodiments, the batter compositions can be provided as predeposited batter compositions that are relatively more viscous and non-pourable. In further embodiments, the batter composition is sufficiently viscous to be extrudable.

In some aspects, the invention provides the ability to formulate batter compositions to provide a desired viscosity. Thus, batter formulations possessing a viscosity profile that allow the product to be pourable from a container can be provided. Flowable batters would be characterized by not having an yield stress value, and being able to flow under their own weight. In other aspects, batter formulations could be designed to be generally non-flowable. These batters would possess a yield stress value, which, after a force of this value being applied to the batter, will allow this batter to flow. The rate of flow will be dependent on the temperature, the shear rate of the applied force, and how the product formula responds to the shear rate applied. These non-pourable batters can be used when it is desired to be in a pre-deposited container, for example, a baking pan or muffin tin. Of course, batter compositions can be formulated to possess viscosities outside these ranges and intermediate to these ranges, in accordance with the principles discussed herein.

In further aspects, the batter compositions can have a density in the range of about 0.8 g/cc to about 1.2 g/cc. The density can depend upon such factors as the final baked or cooked good to be prepared from the batter compositions, and the like. Illustrative densities for batter compositions include the following: 0.78 g/cc to 1.2 g/cc (cakes); 1 g/cc to 1.1 g/cc (muffins); 1 g/cc to 1.04 g/cc (pancakes). Other attributes of the inventive batter compositions can be comparable to conventional batters, such as pH and water activity. Illustrative pH ranges for batter compositions of the invention are relatively neutral, in the range of about 6.6 to about 7.4. Illustrative water activity for the inventive batter compositions can be about 0.98 or less (for example, for compositions such as pancake batters), or in the range of about 0.94 to about 0.8.

### Formulation

Batter compositions of the invention can generally be prepared by preparing a dry premix of minor dry ingredients and mixing for a sufficient time to blend the dry minor ingredients. A presolution is formed by preweighing water and glycerol and blending well together. The flour replacement ingredient is prepared by combining the native starch and protein (and optionally, modified starch and/or fiber) and blending well. If a minor amount of flour is included, it can be combined as well. The dry premix is added to the fat source with mixing, followed by the presolution and flour replacement ingredient alternately. Once all ingredients are combined, the mixture is mixed at high speed until mixing is complete. One illustrative formulation for batter compositions is as follows:

| Ingredient | Useful ranges (weight percent) |
|---|---|
| Flour replacement ingredient | 12-25 |
| Sweetening agent | 5-55 |
| Water | 5-40 |
| Fat source | 0-25 |
| Leavening system | 0-5 |
| Minor ingredients | 0-6 |

One illustrative formulation for batter compositions suitable for microwave cooking, and a comparison to a farinaceous batter formulation for chocolate cake, is as follows:

### Microwaveable Chocolate Cake Batter.

| Description | Flour (%) | Starch (%) |
|---|---|---|
| Sweeteners | 25.14 | 25.14 |
| Water | 27.06 | 27.06 |
| Fat | 19.41 | 19.41 |
| Flour | 13.68 | 0 |
| Egg white | 2.35 | 2.35 |
| Cocao | 4.47 | 4.47 |
| Humectant | 3.53 | 3.53 |
| Leavening agents | 1.18 | 1.18 |
| Minors | 3.16 | 3.16 |
| Wheat starch | 0 | 11.63 |
| Wheat protein | 0 | 1.37 |
| Wheat fiber | 0 | 0.68 |
| Total | 99.99 | 99.99 |

After mixing is complete, the batter is provided into a filler, and the batter is placed in suitable containers. The containers can be of any desired type, such as a tub with a snap-on lid made of a material such as polypropylene, linear low-density polypropylene, or other suitable material. Other suitable containers can include pouches or other more flexible containers. The containers need not be hermetically sealed or pressurized to provide the batter with good stability under refrigerated or ambient temperatures. A shrink band can be included to provide evidence of tampering.

In some aspects, the inventive batter formulations can provide processing flexibility, as the batter compositions do not require modified atmosphere processing. For example, in some aspects, the batter compositions do not require vacuum and/or nitrogen gas flush during mixing of the components of the batter. Use of the inventive leavening systems as described herein, and in particular leavening systems including dimagnesium phosphate trihydrate as the major acidic leavening agent, can allow for such processing efficiency, for example, by eliminating extra processing equipment (since it may not be necessary to eliminate all oxygen from the formulation process to avoid color changes in the batter composition).

In some embodiments, the batter compositions are packaged in a modified atmosphere such as an atmosphere that includes an artificially high concentration of one or more of nitrogen or carbon-dioxide compared to ambient atmospheric air. In some aspects, it can be useful to actively remove oxygen from the product and package environment to prevent or reduce microbial spoilage of the batter composition. As discussed herein, utilization of the flour replacement ingredient substantially reduces or eliminates the presence of enzymes that can cause batter discoloration. Thus, in some aspects, modified atmosphere packaging is not required.

When modified atmosphere packaging is desired, oxygen can be removed from the package/product system by a variety of techniques, including, for example, 1) vacuum packaging, 2) providing a modified packaging atmosphere of nitrogen, carbon dioxide or combination thereof, or 3) actively removing oxygen using oxygen absorbing sachets (metal based oxidation reaction) or enzymatically removing oxygen by adding glucose oxidase to the batter composition.

### Preparation of Baked or Cooked Products

In some aspects, the batter compositions according to the invention are formulated to be prepared in a conventional oven, to provide cooked products. The inventive batter compositions can be removed from the refrigerator or ambient storage package and cooked into high quality cooked foods such as muffins, pancakes, brownies, waffles and other products. In some aspects, for example, when the viscosity of the batter provides a pourable batter composition, the batter is poured from the container into a baking pan or onto a griddle or waffle iron and cooked under normal conditions, for example, in a 350°-375° F. (176° C.-191° C.) oven for a sufficient amount of time to fully cook the product. In other aspects, for example, when the viscosity of the batter provides a non-pourable composition, the batter can be provided as a predeposited composition within a baking container, such as a pan. In these aspects, the baking container is simply removed from the exterior packaging and placed into the baking environment for a sufficient amount of time.

In accordance with these aspects, the container can be any suitable container, including, for example, cup, bowl, pan, pouch, and the like. In some aspects, the invention provides a food package comprising a container suitable for baking, and at least a batter composition disposed in the container. Optionally, the batter can include a filling, flavoring, and/or topping component. The filling, flavoring, and/or topping component can be included with the batter composition, or in a container separate from, and proximate to, the batter composition. The filling, flavoring, and/or topping component can be provided as a liquid, semi-liquid, solid (including particulate solids) or other suitable form.

In further embodiments, the invention provides a food package kit comprising a container suitable for baking, and at least a batter composition located proximate to the container. The food package kit also includes a retaining element for maintaining the batter composition proximate to the container. The retaining element can be a heat seal that is placed over the container to seal the batter composition in the interior of the container. Alternatively, the retaining member can be a shrink wrap that is disposed over the container to hold the batter in the interior of the container. Optionally, an outer sleeve can be provided in conjunction with the container, wherein the sleeve is designed to hold the container firmly in place within the sleeve. Optionally, the batter can include a filling, flavoring, and/or topping component. The filling, flavoring, and/or topping component can be included with the batter composition, or in a container separate from, and proximate to, the batter composition. The filling, flavoring, and/or topping component can be provided as a liquid, semi-liquid, solid (including particulate solids) or other suitable form.

In still further aspects, the batter compositions according to the invention are formulated to be cooked in a microwave oven to provide a final cooked product. Thus, in some embodiments, the batter compositions can be provided as a shelf stable batter that has a shelf life of 3 months or more, or 6 months or more, and that is formulated to rise in the microwave and remain moist after cooking.

In accordance with these aspects, the batter can be placed in a suitable container for microwave cooking. One suitable container is described, for example, in U.S. application Ser. No. 11/332,492, filed Jan. 13, 2006 and entitled “Container to Facilitate Microwave Cooking and Handling.” Other suitable containers include pouches or other containers that include the batter composition. In some aspects, portions of the container remain cool to the touch upon microwave cooking. For example, it can be beneficial to provide a container, such as a bowl, that includes a rim or flange that remains cool to the touch upon microwave cooking, and thus can be grasped by the consumer when cooking the batter composition to provide a cooked product. The microwavable container can be fabricated from any suitable material known for microwave heating of food products, such as, for example, polyolefins (e.g., polypropylene, polyethylene), blends of polyolefins, polystyrene—HIPS, or polyester resin-based materials—CPET, foamed polypropylene, polyethylene), blends of polyolefin's polystyrene—HIPS, or polyester resin-based materials—CPET, paper and paper laminations with polypropylene, polyester, and the like. Optionally, the batter is packaged under modified atmosphere conditions.

In still further aspects, the invention provides a food package comprising a container suitable for microwave cooking, and at least a batter composition disposed in the container. Optionally, the batter can include a filling, flavoring, and/or topping component. The filling, flavoring, and/or topping component can be included with the batter composition, or in a container separate from, and proximate to, the batter composition. The filling, flavoring, and/or topping component can be provided as a liquid, semi-liquid, solid (including particulate solids) or other suitable form.

In further embodiments, the invention provides a food package kit comprising a container suitable for microwave cooking, and at least a batter composition located proximate to the container. The food package kit also includes a retaining element for maintaining the batter composition proximate to the container. The retaining element can be a heat seal that is placed over the container to seal the batter composition in the interior of the container. Alternatively, the retaining member can be a shrink wrap that is disposed over the container to hold the batter in the interior of the container. Optionally, an outer sleeve can be provided in conjunction with the container, wherein the sleeve is designed to hold the container firmly in place within the sleeve. Optionally, the batter can include a filling, flavoring, and/or topping component. The filling, flavoring, and/or topping component can be included with the batter composition, or in a container separate from, and proximate to, the batter composition. The filling, flavoring, and/or topping component can be provided as a liquid, semi-liquid, solid (including particulate solids) or other suitable form.

According to the invention, any suitable portion size of the batter composition can be included in the microwavable container. In some embodiments, small portions, such as 25-gram portions of batter, can be included in the microwavable container. These small portions of batter, combined with relatively short cook times in the microwave environment create a relatively small window of tolerance for cooking the batter compositions. In preferred aspects, the container is designed to provide uniform, consistent heating of the batter composition during microwave cooking.

The invention can, in some aspects, provide significant benefits in terms of preparation and storage, while also providing a baked or cooked product that is comparable to cooked products prepared using conventional techniques (such as fresh batter preparation). The baked or cooked products can be comparable in terms of product attributes such as texture, mouthfeel, moistness, and specific volume. In some aspects, the batter compositions can be used to prepare baked or cooked goods having baked specific volume (BSV) for muffins of about 1.8-2.2 cc/g, or about 2 cc/g. In some aspects, the batter compositions can be used to prepared baked or cooked products having a pH level that is neutral to slightly basic. The pH of the baked/cooked product can be impacted by the amount of basic leavening agent (such as soda) that reacted during baking or cooking. The relative pH of the final product can impact organoleptic quality of the baked or cooked good.

While the invention is specifically described in terms of improved baked or cooked goods, such as layer cakes, muffins, quick breads, cupcakes, biscuits, corn breads, and the like, the batter compositions can be used for or formulated for use to prepare other baked or cooked goods within the scope of the invention, including griddle cakes such as pancakes, crepes, or cornbreads, Irish soda breads or waffles. Also, while the present articles are especially suited for use in preparing leavened finished goods, other finished goods can also be prepared therefrom.

The invention will now be described with reference to the following non-limiting examples.

### EXAMPLES

### Preparations

For the preparations described in these Examples, bench top samples were prepared and evaluated. Unless specifically stated otherwise, reference to a mixer and mixing steps for preparation of the batter composition refer to a Kitchen Aid standard countertop mixer, the stated speeds based upon speeds of the mixer used.

### Example 1

### Sample 1: Cake Batter Composition According to Embodiment of the Invention (Flour Replacement Ingredient Including Native Starch with Protein and Fiber)

| Formula | Ingredient | Formula % |
|---|---|---|
| Flour replacement | Native wheat starch | 18.5 |
| ingredient | | |
| | Protein source | 2.6 |
| | Fiber source | 1.3 |
| | Sweetener | 29.4 |
| | Oil | 18 |
| | Water | 22 |
| Dry Mix | Leavening System | 0.9 |
| | Egg solids | 3.5 |
| | Minors | 3.7 |
| | Total | 100 |

The leavening system in this formulation was sodium bicarbonate, monocalcium phosphate, and SALP.

### Process

1. The Dry Mix ingredients were combined and mixed for 5 minutes at medium speed, blend well.
2. Water and a liquid portion of the sweetener were combined and blended together.
3. The flour replacement ingredient was prepared by combining native wheat starch, protein source and fiber source. The mixture was blended by hand.
4. Oil was added to a 6-quart mixing bowl. The mixer was turned on at low speed. With the mixer running at low speed, the Dry Mix ingredients were added, followed by addition of the presolution prepared in Step #2. Addition of the presolution of Step 2 was alternated with addition of the flour replacement ingredient prepared in Step #3. Between additions, the mixture was observed to ensure blending of the components.
5. The mixture was then mixed at high speed for an additional 5 minutes.

### Samples 2-4: Cake Batter Compositions According to Embodiments of the Invention (Flour Replacement Ingredient Including Various Native Starches)

For these samples, the native wheat starch of Sample 1 was replaced with various native starches, as summarized in Table 2 below. The batters were prepared as described for Sample 1 above.

TABLE 2
Starches

| Sample No. | Native Starch |
|---|---|
| 2 | Native corn |
| 3 | Native potato starch |
| 4 | Native tapioca starch |

### Samples 5-11: Cake Batter Compositions According to Embodiments of the Invention (Flour Replacement Ingredient Including Various Protein Sources)

For these samples, various protein sources were utilized in the formulation of Sample 1, as summarized in Table 3 below. In addition, a sample including no added protein source (within the flour replacement ingredient) was evaluated. The batters were prepared as described for Sample 1 above, wherein the percentage protein indicates the percentage of flour replacement ingredient.

TABLE 3
Proteins and starches within flour replacement ingredient.

| Sample | |
|---|---|
| No. | Protein |
| 5 | Wheat protein isolate (90% protein) |
| 6 | Soy (90% protein) |
| 7 | Whey protein concentrate (80% protein) |
| 8 | Caseinate (80% protein) |
| 9 | Albumen (80% protein) |
| 10 | Egg yolk solids (35% protein) |
| 11 | No added protein |

### Comparative Sample: Cake Flour.

For this comparative sample, pound cake flour was utilized. All other ingredients in the formulation were the same as Sample 1. The comparative sample was prepared as described for Sample 1.

| Formula | Ingredient | Formula % |
|---|---|---|
| | Flour | 22.4 |
| | Sweetener | 29.4 |
| | Oil | 18 |
| | Water | 22 |
| Dry Mix | Leavening System | 0.9 |
| | Minors | 7.2 |
| | Total | 100 |

### Preparation of Baked Products and Evaluations.

A portion of each sample was weighed to 450 grams and placed into a cake loaf pan. For all Samples prepared, A_{w}=0.84, pH=7.69. The batters of each sample were baked at 350° F. for 40-45 minutes.

Various properties of the prepared samples were observed, including cake volume, cell structure of the baked product (size and uniformity), and baked product quality. Results are summarized in Table 4:

TABLE 4
Baked product attributes.

| Sample No. | Cake Volume | Cell Structure | Quality |
|---|---|---|---|
| 1 | High | Medium-fine | Excellent |
| 2 | Low | Coarse | Poor |
| 3 | High | Fine | Good |
| 4 | Low | Coarse | Poor |
| 5 | High | Medium-fine | Good |
| 6 | High | Fine | Excellent |
| 7 | High | Coarse | Good |
| 8 | High | Coarse | Good |
| 9 | High | Coarse | Good |
| 10 | High | Coarse | Good |
| 11 | High | Coarse/crumbly | Poor |
| Comparative | Medium-high | Medium-fine | Good |

For overall baked product quality, such attributes as volume, appearance of the cake, cell structure, and taste were evaluated.

Results demonstrated that Samples 2-4, prepared with various native starches can provide acceptable baked product. Results further demonstrate that Samples 5-10, prepared with a flour replacement ingredient comprising native starch, various protein sources, and fiber, provided acceptable baked products. It is understood that even Samples having a “poor” baked product quality could be manipulated in accordance with principles of the invention to provide acceptable baked products.

### Example 2

Cake batter formulations were prepared for yellow and chocolate cakes, with each cake batter including standard cake flour or flour replacement ingredient comprised of starch. Formulations are summarized in Tables 5 and 6.

TABLE 5
Yellow Cake Batter.

| Description | Flour (%) | Starch (%) |
|---|---|---|
| Sweeteners | 26.42 | 26.42 |
| Flour | 22.43 | 0 |
| Water | 18 | 18 |
| Fat | 18 | 18 |
| Egg | 3.5 | 3.5 |
| Humectants | 3 | 3 |
| Minors | 3.65 | 3.65 |
| Leavening agents | 1 | 1 |
| Wheat protein | 0 | 2.61 |
| Wheat fiber | 0 | 1.3 |
| Starch | 0 | 18.52 |
| Total | 100 | 100 |

TABLE 6
Chocolate Cake Batter.

| Description | Flour (%) | Starch (%) |
|---|---|---|
| Sweeteners | 25 | 25 |
| Water | 22 | 22 |
| Fat | 20 | 20 |
| Flour | 17 | 0 |
| Egg | 4 | 4 |
| Cocao | 3.6 | 3.6 |
| Humectant | 3 | 3 |
| Leavening agents | 2.4 | 2.4 |
| Minors | 3 | 3.5 |
| Wheat starch | 0 | 13 |
| Wheat protein | 0 | 2.5 |
| Wheat fiber | 0 | 1 |
| Total | 100 | 100 |

The batters were prepared as described for Sample 1 of Example 1 above. A portion of each batter was weighed to 500 grams in an 8.5×4.75 inch cake loaf pan. The batters of each sample were baked at 350° F. for 40-45 minutes.

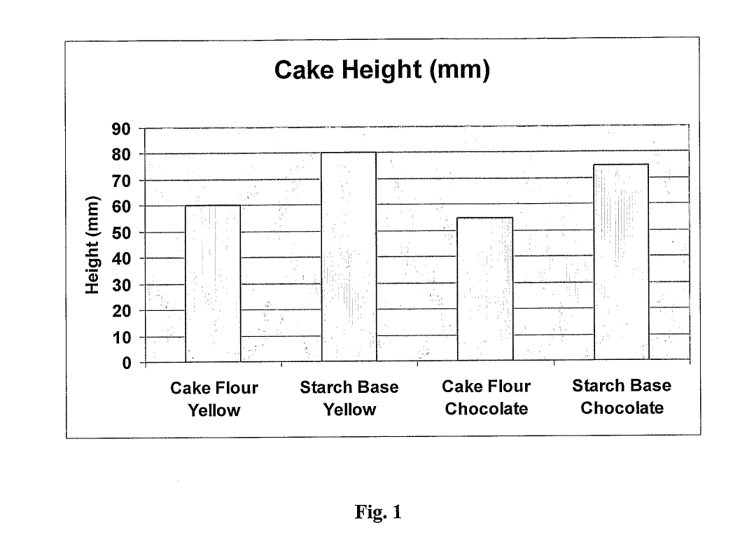

Cake height was measured for each batter. Results are summarized in Table 7 and FIG. 1:

TABLE 7
Cake height.

| | Height range | Average |
|---|---|---|
| Formulation | (mm) | height (mm) |
| Cake flour yellow | 55-65 | 60 |
| Starch base yellow | 70-90 | 80 |
| Cake flour chocolate | 50-60 | 55 |
| Starch base chocolate | 65-85 | 75 |

Results illustrate an improved cake height for baked products prepared from batter compositions including starch as a flour replacement ingredient, as compared to batter compositions including standard cake flour. Cake heights increased by an average of 20 mm for both yellow and chocolate cake batters.

### Example 3

Color change of batter compositions over time for batters made in accordance with aspects of the invention were observed and compared with color change for conventional batters including flour. Batter compositions were prepared with the following formulations of Table 8:

TABLE 8
Batter Formulations.

| | | Flour replacement |
|---|---|---|
| Ingredient | Cake Flour | ingredient |
| Cake flour | 22.43 | |
| Starch | | 18.52 |
| Wheat protein isolate (Arise 6000) | | 2.61 |
| Wheat fiber | | 1.3 |
| Sweetener | 26.42 | 26.42 |
| Fat/oil | 18 | 18 |
| Water | 22 | 22 |
| Humectants | 3 | 3 |
| Leavening agents | 0.92 | 0.92 |
| Minors | 7.23 | 7.23 |
| Total | 100 | 100 |

Batters were prepared as described for Sample 1 in Example 1 above. For each batter, five aliquots of batter (250 g each) were placed in five separate containers. Batter samples were maintained at room temperature during evaluation. At each sampling point, one container was taken from the test and placed into the freezer. On Day 5, all samples were removed from the freezer and evaluated for color change.

Color of the batter was measured by obtaining lightness (L) values for the batter surface for each sample using a Minolta colorimeter (Model Chroma Meter CR-410) which was set against a white reference tile (L=96.86, a=−0.06 and b=2.00). The color scale used to evaluate the samples was the Hunter L/a/b scale, which measure color as:

L (lightness) axis—0 is black, 100 is white;

a (red-green) axis—positive values are red; negative values are green and 0 is neutral; and

b (yellow-blue) axis—positive values are yellow; negative values are blue and 0 is neutral.

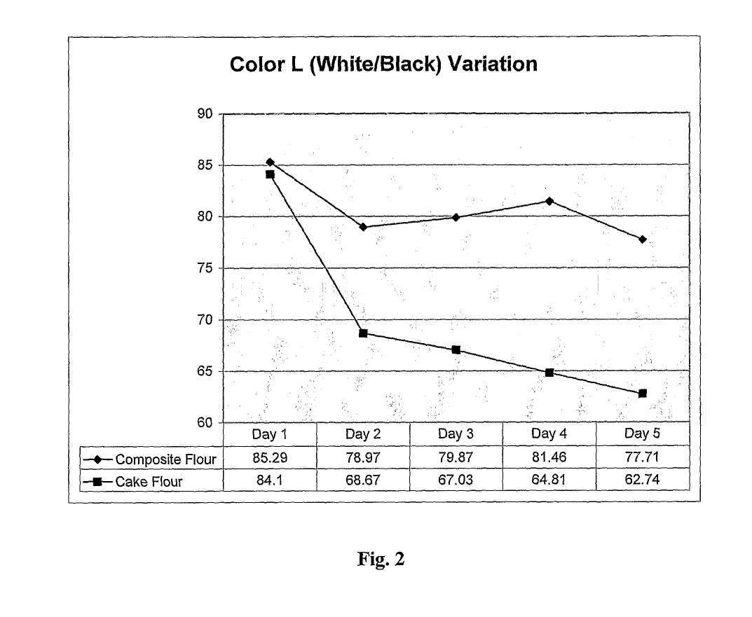

This scale can also measure the color difference between a sample and a standard color. Color difference is calculated as SAMPLE minus STANDARD and is frequently stated with the Δ symbol.
If ΔL is positive, then the sample is lighter than the standard. If negative, it would be darker than the standard.
If Δa is positive, then the sample is more red (or less green) than the standard. If negative, it would be more green (or less red).
If Δb is positive, then the sample is more yellow (or less blue) than the standard. If negative, it would be more blue (or less yellow).
Results of the color analysis for batter surfaces are illustrated in FIGS. 2-4 and the following Table 9.

TABLE 9

| | | Composite | Cake |
|---|---|---|---|
| L/a/b value: | | Flour | Flour |
| Day 1 | L | 85.29 | 84.1 |
| | a | −0.95 | 0.33 |
| | b | 23.45 | 23.82 |
| Day 2 | L | 78.97 | 68.67 |
| | a | 0.89 | 1.73 |
| | b | 29.79 | 23.34 |
| Day 3 | L | 79.87 | 67.03 |
| | a | 1.12 | 1.93 |
| | b | 30.58 | 21.98 |
| Day 4 | L | 81.46 | 64.81 |
| | a | 0.83 | 2.04 |
| | b | 31.58 | 20.86 |
| Day 5 | L | 77.71 | 62.74 |
| | a | 1.29 | 2.45 |
| | b | 30.8 | 20.5 |

FIG. 2 and Table 9 illustrate the “L” (lightness) values for the batters over the experiment. As shown in FIG. 2 and Table 9, the color of both samples dropped dramatically from Day 1 to Day 2. The ΔL value of the cake batter containing cake flour was larger than the batter in accordance with the invention, indicating a more dramatic color change for the cake batter containing cake flour. After Day 1, L value for the batter containing flour replacement ingredient remained relatively constant, while the L value for the batter containing cake flour continued to change, indicating that the batter with cake flour kept getting darker at each sampling point.

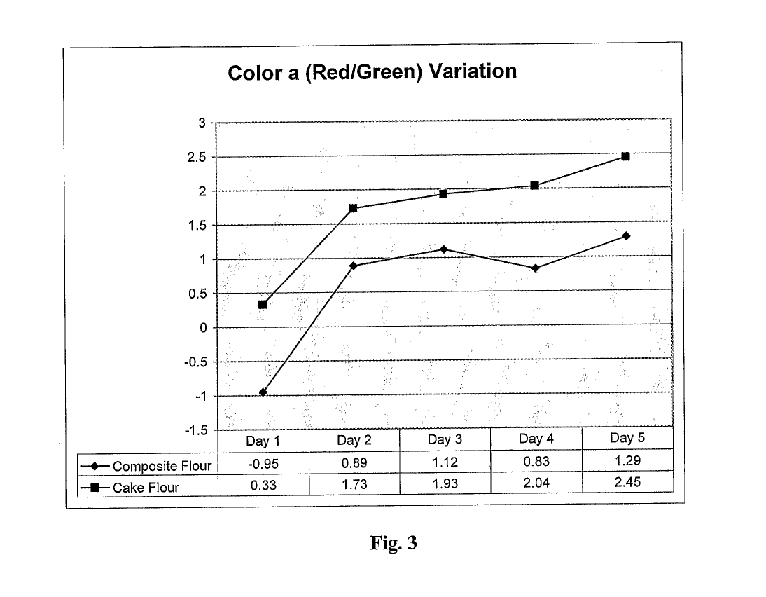

FIG. 3 and Table 9 illustrate the “a” (red/green) values for the batters over the experiment. As illustrated in FIG. 3 and Table 9, the Δa values for both samples followed a similar trend over the time course of the experiment.

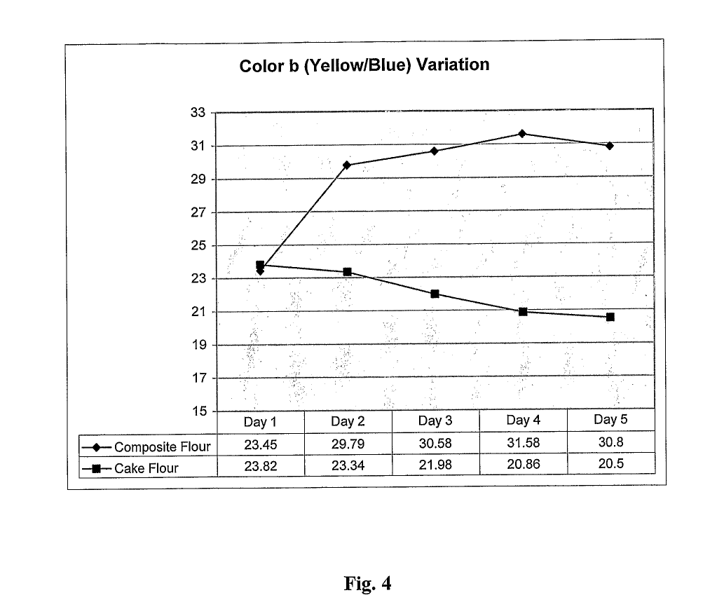

FIG. 4 and Table 9 illustrate the “b” (yellow/blue) values for the batters over the experiment. As illustrated, the batter in accordance with the invention (containing flour replacement ingredient) became more yellow in color over the time course of the experiment. Conversely, the batter containing cake flour became more blue in color over the time course.

With respect to the batter interior, the following observations were made. For batter containing cake flour, color change over five days of ambient storage followed the same pattern as the surface color, but was observed to be lighter than the surface color. For batter containing flour replacement ingredient, the batter interior color was the same as the surface color for each individual sample container.

### Example 4

For this Example, three samples containing different leavening acids were prepared and evaluated. Formulations for the samples are summarized in Table 10 below:

TABLE 10

| | Description | | | |
|---|---|---|---|---|
| | Yellow Cake | | | |
| | Soda | e-Soda | Soda | Chocolate |
| | DCP/ | DCP/ | DMP/ | Cake |
| | e-SAPP | SALP | MCP | DMP Soda |
| Sweeteners | 21 | 21 | 21 | 18 |
| Water | 20.5 | 20.5 | 20.5 | 23 |
| Fat | 14.5 | 14.5 | 14.5 | 15 |
| Dry Egg | 4.6 | 4.6 | 4.6 | 4 |
| Humectants | 3 | 3 | 3 | 3 |
| Minors | 7 | 7 | 7 | 6 |
| Leavening agents | | | | |
| Baking Soda | 0.5 | 0 | 0.5 | 0.75 |
| Encapsulated Soda | 0 | 0.63 | 0 | 0 |
| DMP | 0 | 0 | 0.93 | 0.92 |
| MCP | 0 | 0 | 0.11 | 0.11 |
| SALP | 0 | 0.3 | 0 | 0 |
| Encapsulated SAPP | 0.75 | 0 | 0 | 0 |
| Dicalcium phosphate | 0.47 | 0.47 | 0 | 0 |
| Wheat Protein | 1.8 | 1.8 | 1.8 | 2.1 |
| Wheat Fiber | 1.2 | 1.2 | 1.2 | 1.77 |
| Wheat Starch | 17.3 | 17.3 | 17.3 | 14 |
| Chocolate Chips | 7.5 | 7.5 | 7.5 | 7.4 |
| Cocoa | | | | 3.5 |
| Total | 100 | 100 | 100 | 100 |

Batter compositions were prepared as described for Sample 1 in Example 1. Batter compositions were then packaged as follows. An amount of the batter (550 grams) was deposited in a flexible film, metalized, gusseted pouch that had barrier properties to oxygen. The headspace was flushed with 25% carbon dioxide (CO₂)/75% nitrogen (N₂) gas mixture, and then immediately sealed. Samples were held at 45° F. and at room temperature.

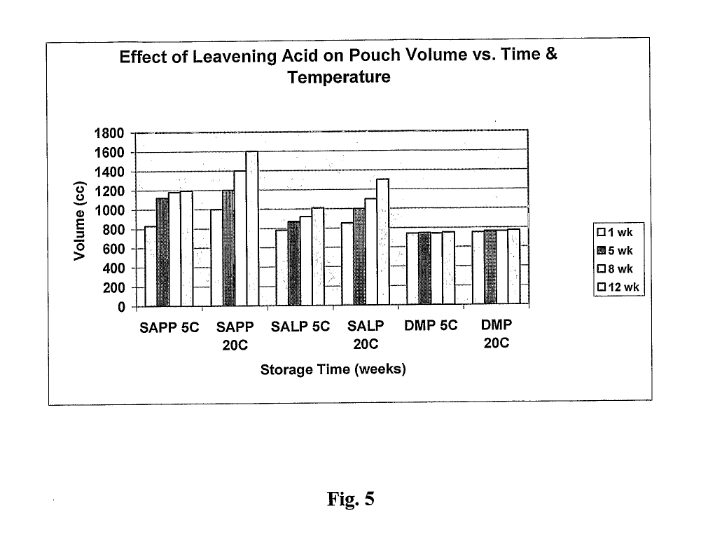

Table 11 and FIG. 5 illustrate pouch volume over time for the various leavening systems prepared in this Example (in FIG. 5, “SAPP” is encapsulated SAPP, as shown in Table 11). As illustrated, samples prepared in accordance with aspects of the invention, wherein DMP was utilized as the acidic leavening agent, provided lower pouch volume over time. The samples in accordance with the invention thus produced less leavening gas over several weeks, when the batters were stored at refrigerated or ambient temperatures.

TABLE 11
Effect of Storage Temperature on Pouch Volume for Yellow Cake
Batter: 550 g pouch flashed with 25% N₂/75% CO₂
Pouch Volume: Measured by water displacement method (cc)

| | | SAPP | SAPP | SALP | SALP | DMP/MCP | DMP/MCP |
|---|---|---|---|---|---|---|---|
| Time | | 5° C. | 20° C. | 5° C. | 20° C. | 5° C. | 20° C. |
| 1 | wk | 830 | 1000 | 780 | 850 | 740 | 750 |
| 5 | wk | 1120 | 1200 | 870 | 1000 | 745 | 760 |
| 8 | wk | 1180 | 1400 | 920 | 1100 | 740 | 760 |
| 12 | wk | 1195 | 1600 | 1010 | 1300 | 750 | 770 |

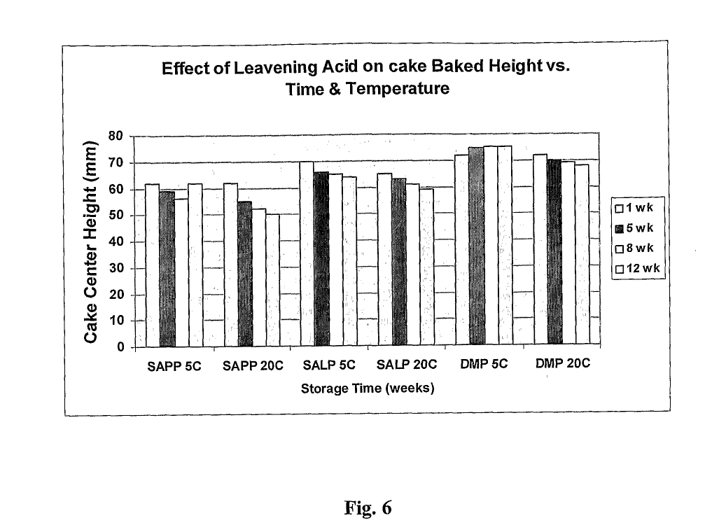

Batters were stored at refrigerated temperatures (38-45° F.) or ambient temperatures (65-85° F.) for a period of twelve (12) weeks. Next, 500 g of batter was weighed into a loaf pan (22×12 cm, 8.5 inches×4.75 inches) and baked at 350° F. for 45 minutes. The height of the baked product was measured at the highest point in the center of the cake. Results are illustrated in Table 12 and FIG. 6 (in FIG. 6, “SAPP” is encapsulated SAPP, as described in Table 10).

TABLE 12
Effect of Storage Temperature on Baked Height for Yellow Cake Batter:
500 g in 22 cm pan
Cake Center height (mm)

| | | SAPP | SAPP | SALP | SALP | DMP/MCP | DMP/MCP |
|---|---|---|---|---|---|---|---|
| Time | | 5° C. | 20° C. | 5° C. | 20° C. | 5° C. | 20° C. |
| 1 | wk | 62 | 62 | 70 | 65 | 72 | 72 |
| 5 | wk | 59 | 55 | 66 | 63 | 74.8 | 70 |
| 8 | wk | 56 | 52 | 65 | 61 | 75 | 69 |
| 12 | wk | 62 | 50 | 64 | 59 | 75 | 68 |

Results illustrate that cakes prepared with DMP/MCP as the acidic leavening agent provided superior baked product height as compared to leavening systems including encapsulated SAPP (E-SAPP) and SALP with encapsulated soda. The improved baked product height was maintained over time.

### Example 5

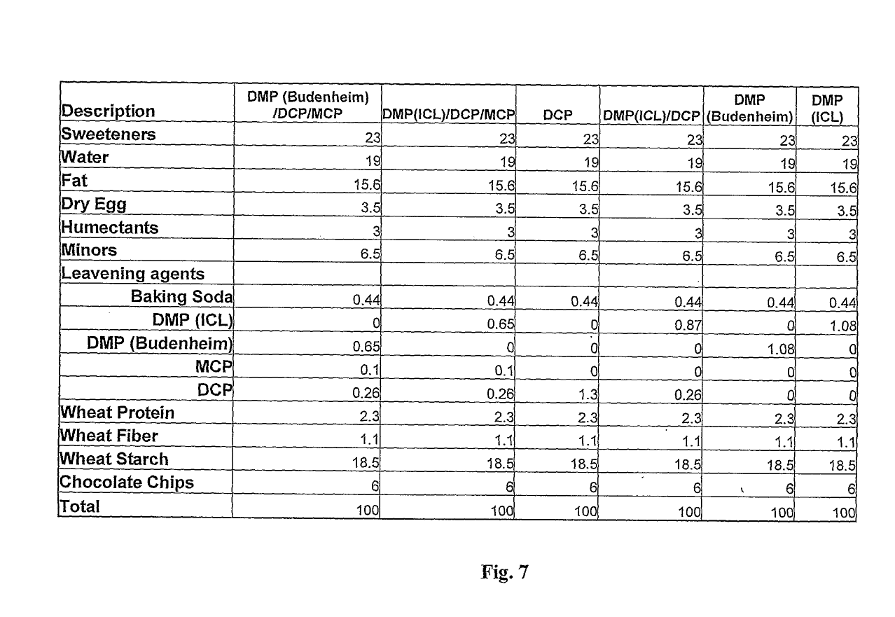

Several batter compositions, including yellow cake batter and chocolate cake batter compositions, were formulated to contain different leavening systems. The batter compositions prepared are summarized in the table of FIG. 7.

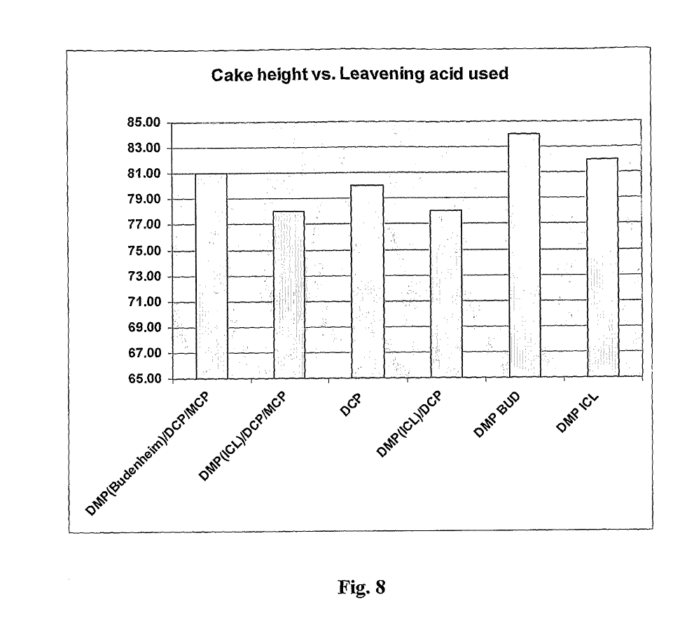

Batter compositions were prepared as described for Sample 1 in Example 1. Baked products were prepared as described in Example 1. Baked product height is illustrated in FIG. 8. As shown, Batter compositions including DMP as the sole leavening acid provided superior baked product height.

Other embodiments of this invention will be apparent to those skilled in the art upon consideration of this specification or from practice of the invention disclosed herein. Variations on the embodiments described herein will become apparent to those of skill in the relevant arts upon reading this description. The inventors expect those of skill to use such variations as appropriate, and intend to the invention to be practiced otherwise than specifically described herein. Accordingly, the invention includes all modifications and equivalents of the subject matter recited in the claims as permitted by applicable law. Moreover, any combination of the above-described elements in all possible variations thereof is encompassed by the invention unless otherwise indicated. All patents, patent documents, and publications cited herein are hereby incorporated by reference as if individually incorporated. In case of conflict, the present specification, including definitions, will control.

We claim:

1. A batter composition comprising:
a) a structure-providing amount of a flour replacement ingredient comprising native starch in an amount of 70% by weight or more, and a protein source in an amount of 30% by weight or less, weight percentages based upon weight of the flour replacement ingredient;
b) a sweetener in an amount effective to provide a water activity of 0.94 or less; and
c) a fat source;
wherein the batter composition has a pH of 6.5 or higher.

2. The composition according to claim 1 wherein the native starch is present in an amount sufficient to provide a flour replacement ingredient-to-sweetener ratio in the range of 1:1 to 1.4:1.

3. The composition according to claim 1 wherein the native starch comprises wheat starch, corn starch, potato starch, tapioca starch or a combination of any of these.

4. The composition according to claim 1 wherein the flour replacement ingredient further comprises modified starch in an amount of 5% by weight or less, based on total weight of the batter composition.

5. The composition according to claim 1 wherein the protein source comprises gluten, wheat protein, soya protein, sodium caseinate, gelatin, milk protein, whey protein, or a combination of any of these.

6. The composition according to claim 1 wherein the flour replacement ingredient further comprises a fiber source.

7. The composition according to claim 6 wherein the fiber source comprises 20% or less by weight of the flour replacement ingredient.

8. The composition according to claim 6 wherein the fiber source comprises wheat fiber, gum, vegetable gums such as alginates, carrageenan, dextran, furcellaran, pectin, gelatin, gum agar, locust bean gum, gum ghatti, guar gum, gum tragacanth, acacia, gum arabic, xanthan gum, karaya gum, tara gum, cellulose derivatives; soluble and insoluble dietary fiber, wood pulp cellulose, seed husks, oat hulls, citrus fiber, pea fiber, corn bran, soy polysaccharide, oat bran, wheat bran, barley, rice bran, gellan gum, or a combination of any of these.

9. The composition according to claim 1 wherein the batter composition has reduced polyphenol oxidase activity as compared to a batter composition that comprises a structure-providing amount of flour.

10. The composition according to claim 9 wherein the batter composition has a polyphenol oxidase activity of 0.1 AU/0.1 g or less.

11. The composition according to claim 1 further comprising a leavening system.

12. The composition according to claim 11 wherein the leavening system comprises a chemical leavening system.

13. The composition according to claim 12 wherein the chemical leavening system comprises dimagnesium phosphate trihydrate as a major acidic leavening agent, in combination with a basic leavening agent.

14. The composition according to claim 1 wherein the composition is formulated for storage at refrigerated or ambient temperatures.

15. The composition according to claim 14 wherein the batter composition is stable at refrigerated temperatures for a period of at least 60 days.

16. The composition according to claim 1 wherein the batter composition has a Hunter L/a/b color value of 30 or greater at 5 days storage at ambient temperatures.

17. The composition according to claim 1 further comprising flour in an amount of 5% by weight, based on weight of the batter composition.

18. A flour replacement ingredient for use in providing structure to a batter, the flour replacement ingredient comprising:
a) at least 70% by weight of native starch,
b) protein source in an amount of 30% by weight or less,
c) fiber source in an amount of 20% by weight or less,
weight percentages based on total weight of the flour replacement ingredient.

19. A method of formulating a batter composition comprising:
a) providing a flour replacement ingredient comprising starch and protein source,
b) combining the flour replacement ingredient with sweetener and fat source to provide a batter composition,
wherein the starch of the flour replacement ingredient includes at least native starch, and can further include modified starch in an amount in the range of 0 to 5% based on total weight of the batter composition, and wherein the amount of modified starch in the batter composition is selected to provide a desired viscosity to the batter composition,
and wherein the flour replacement ingredient is present in an amount sufficient to provide structure to the batter.

20. A batter composition comprising:
a) a structure-providing amount of flour or flour replacement ingredient;
b) sweetener in an amount effective to provide a water activity of 0.94 or less;
c) fat source; and
d) a chemical leavening system,
the chemical leavening system comprising a basic leavening agent and an acidic leavening agent, wherein dimagnesium phosphate trihydrate comprises at least 75% by weight of the acidic leavening agent.

21. The batter composition according to claim 20 comprising a flour replacement ingredient, the flour replacement ingredient comprising at least 70% by weight native starch and 30% or less of a protein source, weight percentages based on total weight of the flour replacement ingredient.

22. The batter composition according to claim 21 wherein the flour replacement ingredient further comprises modified starch in an amount of 5% or less, based on weight of the batter composition.

23. The batter composition according to claim 21 wherein the flour replacement ingredient further comprises a fiber source.

24. A food package kit comprising:
a) a container suitable for microwave cooking;
b) at least one batter composition disposed in the container, the batter composition comprising a flour replacement ingredient comprising at least 70% by weight native starch and 30% by weight or less of a protein source; a sweetener in an amount effective to provide a water activity of 0.94 or less; and a fat source, wherein the flour replacement ingredient is present in a structure-providing amount.

25. A food package kit comprising:
a) a container suitable for baking in an oven; and
b) at least a batter composition located proximate to the container, the batter composition comprising a flour replacement ingredient comprising at least 70% by weight native starch and 30% by weight or less of a protein source; a sweetener in an amount effective to provide a water activity of 0.94 or less; and a fat source, wherein the flour replacement ingredient is present in a structure-providing amount.

26. The food package kit according to claim 25 further comprising a retaining element for maintaining the batter composition proximate to the container.

27. A batter product comprising two or more batter compositions of claim 1 which have been co-extruded so as to form the batter product.

28. A filled product batter composition comprising a batter composition of claim 1 which has been co-extruded with a filling so as to form the filled product batter composition.
